(19) United States
(12) Patent Application Publication
(10) Pub. No.: US 2026/0194798 A1
(43) Pub. Date: Jul. 9, 2026

(54) ILLUMINATION SYSTEM AND PROJECTION APPARATUS

(71) Applicant: Coretronic Corporation, Hsin-Chu (TW)

(72) Inventors: Min-Chang Chang, Hsin-Chu (TW); Shih-Chen Chiou, Hsin-Chu (TW); Wen-Jui Huang, Hsin-Chu (TW); Wen-Hao Chu, Hsin-Chu (TW)

(73) Assignee: Coretronic Corporation, Hsin-Chu (TW)

(21) Appl. No.: 19/438,662

(22) Filed: Jan. 2, 2026

Related U.S. Application Data
(60) Provisional application No. 63/741,416, filed on Jan. 3, 2025.

(30) Foreign Application Priority Data
Apr. 2, 2025 (CN) 202510406732.9

(51) Int. Cl. G03B 21/20

(52) U.S. Cl. CPC G03B 21/204; G03B 21/208

(57) ABSTRACT

An illumination system for providing an illumination beams is provided. A first light source module and a second light source module respectively provide a first laser beam and a second laser beam. The light splitting and combining module splits the first laser beam reflected from the wavelength conversion device into a first split beam and a second split beam, which enter a condensing lens symmetrically with respect to a central axis of the condensing lens. The light splitting and combining module also splits the second laser beam from the second light source module into a third split beam and a fourth split beam, which enter the condensing lens symmetrically with respect to the central axis, thereby the aforementioned split beams are more evenly distributed in the illumination beam. A projection apparatus including the aforementioned illumination system is also provided.

### CROSS-REFERENCE TO RELATED APPLICATION

This application claims the priority benefit of US provisional application serial no. 63/741,416, filed on January 3, 2025 and China application serial no. 202510406732.9, filed on April 2, 2025. The entirety of each of the above-mentioned patent applications is hereby incorporated by reference herein and made a part of this specification.

### BACKGROUND

### Technical Field

The disclosure relates to an optical system and an optical apparatus, and in particular to an illumination system and a projection apparatus.

### Description of Related Art

The market increasingly emphasizes the vividness of projection, color range, and color accuracy of projection devices. Under this trend, existing photo-luminescence technology struggles to simultaneously meet the requirements for wide color gamut and high brightness, as excitation light often loses significant energy when passing through filter elements. For example, red light produced when excitation light passes through a red filter typically retains less than 15% of the original excitation light energy. Therefore, existing projection apparatus often employs additional supplementary laser light sources to enhance color gamut range and brightness performance. However, laser beams possess highly concentrated characteristics; thus, when the laser beam provided by the supplementary laser light source is output as part of the illumination beam, issues of excessive energy concentration and uneven energy distribution within the illumination beam frequently arise.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

An illumination system and a projection apparatus are provided in the present invention, in which may illumination effect and projection effect with better uniformity may be provided, and the color rendition of the illumination beam or image beam may be enhanced.

The other objectives and advantages of the disclosure may be further understood from the descriptive features disclosed in the present invention.

In order to achieve one of, or portions of, or all of the above objectives or other objectives, an illumination system for providing an illumination beam is provided in an embodiment of the present invention. The illumination system includes a first light source module, a second light source module, a light splitting and combining module, a condensing lens, a wavelength conversion device and a filtering device. The first light source module is configured to provide a first laser beam. The second light source module is configured to provide a second laser beam, and a wavelength range of the first laser beam does not overlap with a wavelength range of the second laser beam. The second light source module has a light outlet for the second laser beam to leave. The wavelength conversion device is disposed on an optical path of the first laser beam and has a first area and a second area. The first area and the second area enter the optical path of the first laser beam at different time periods. The first area reflects the first laser beam. The second area receives the first laser beam and generates a converted beam. A wavelength range of the converted beam at least partially overlaps with the wavelength range of the second laser beam. The light splitting and combining module is disposed on optical paths of the first laser beam, the second laser beam and the converted beam. The first laser beam from the first light source module is transmitted to the light splitting and combining module along a first direction. The second laser beam from the second light source module is transmitted to the light splitting and combining module along a second direction. The first direction is not parallel to the second direction. The light splitting and combining module is configured to allow the first laser beam from the first light source module to pass through, and the light splitting and combining module splits the first laser beam from the first area of the wavelength conversion device into a first split beam and a second split beam in a time period, and transmits the first split beam and the second split beam to the condensing lens along the second direction. The first split beam and the second split beam enter the condensing lens symmetrically with respect to a central axis of the condensing lens. The light splitting and combining module is further configured to split the second laser beam from the second light source module into a third split beam and a fourth split beam in another time period, and then transmit the third split beam and the fourth split beam to the condensing lens along the second direction. The third split beam and the fourth split beam enter the condensing lens symmetrically with respect to the central axis. The light splitting and combining module is configured to change a transmission direction of the converted beam so that the converted beam enters the condensing lens along the second direction. The condensing lens is disposed between the light splitting and combining module and the filtering device, and is configured to converge the first split beam, the second split beam, the third split beam, the fourth split beam and the converted beam, which are transmitted to the filtering device. The illumination beam includes at least one of the following beams passing through the filtering device: the first split beam and the second split beam, the third split beam and the fourth split beam, and at least a portion of the converted beam.

In order to achieve one of, or portions of, or all of the above objectives or other objectives, a projection apparatus is provided in an embodiment of the present invention. The projection apparatus includes the above-mentioned illumination system, a light modulation device and a projection lens. The illumination system is configured to provide the illumination beam. The light modulation device is disposed on a transmission path of the illumination beam to convert the illumination beam into an image beam, and the projection lens is disposed on a transmission path of the image beam to project the image beam out of the projection apparatus.

Based on the above, in the illumination system and projection apparatus of the present invention, the light splitting and combining module splits the first laser beam from the first area of the wavelength conversion device into a first split beam and a second split beam, and directs the first split beam and the second split beam to enter the condensing lens symmetrically with respect to the central axis of the condensing lens to form a portion of the illumination beam, and splits the second laser beam from the second light source module into a third split beam and a fourth split beam, and then directs the third split beam and the fourth split beam to enter the condensing lens symmetrically with respect to the central axis to form a portion of the illumination beam. Therefore, the illumination system and the projection apparatus may provide a more evenly distributed illumination beam, so that the image beam projected by the projection apparatus has a better projection effect.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a block diagram of a projection apparatus according to an embodiment of the present invention.

FIG. 2 is a schematic diagram of an illumination system and its optical path of a first embodiment of the present invention.

FIG. 3A is a schematic diagram of a wavelength conversion device in the illumination system according to the first embodiment of the present invention.

FIG. 3B is a schematic diagram of a filtering device in the illumination system according to the first embodiment of the present invention.

FIG. 4 is a working time period diagram of the illumination system according to the first embodiment of the present invention.

FIG. 5A is a schematic diagram of an optical path of the illumination system in a first time period according to the first embodiment of the present invention.

FIG. 5B is a schematic diagram of an optical path of the illumination system in a second time period according to the first embodiment of the present invention.

FIG. 5C is a schematic diagram of an optical path of the illumination system in a third time period according to the first embodiment of the present invention.

FIG. 6 is a top plan view schematic diagram of a filtering device of an illumination system according to a second embodiment of the present invention.

FIG. 7 is a work time period diagram of the illumination system according to the second embodiment of the present invention.

FIG. 8 is a schematic diagram of an optical path of the illumination system in a fourth time period according to the first embodiment of the present invention.

FIG. 9 is a schematic diagram of light spots formed on a light splitting element by a first laser beam and a second laser beam in the illumination system according to the first embodiment of the present invention.

FIG. 10 is a schematic diagram of light spots formed on a condensing lens by a first laser beam and a second laser beam in the illumination system according to the first embodiment of the present invention.

FIG. 11 is a work time period diagram in the illumination system according to the third embodiment of the present invention.

FIG. 12 is a schematic diagram of an optical path of the illumination system in a fourth time period according to the third embodiment of the present invention.

FIG. 13 is a schematic diagram of an illumination system according to a fourth embodiment of the present invention.

FIG. 14 is a schematic diagram of an illumination system according to a fifth embodiment of the present invention.

FIG. 15A is a schematic diagram of an optical path of the first laser beam of the illumination system in the first time period according to a sixth embodiment of the present invention.

FIG. 15B is a schematic diagram of an optical path corresponding to a first sub-light beam of the illumination system in the second time period according to the sixth embodiment of the present invention.

FIG. 15C is a schematic diagram of an optical path corresponding to a second sub-light beam of the illumination system in the second time period according to the sixth embodiment of the present invention.

FIG. 16 is a three-dimensional schematic diagram of a portion of the elements of a second light source module of the illumination system according to the sixth embodiment of the present invention.

FIG. 17 is a schematic diagram of light spots formed on a light splitting element in the illumination system according to the sixth embodiment of the present invention.

FIG. 18 is a schematic diagram of light spots formed on a condensing lens by each light beam in the illumination system according to the sixth embodiment of the present invention.

FIG. 19A is a schematic diagram of an optical path corresponding to the first sub-light beam of the illumination system in the fourth time period according to a seventh embodiment of the present invention.

FIG. 19B is a schematic diagram of an optical path corresponding to the second sub-light beam of the illumination system in the fourth time period according to a seventh embodiment of the present invention.

FIG. 20 is a schematic diagram of an illumination system according to an eighth embodiment of the present invention.

FIG. 21 is a schematic diagram of an illumination system according to a ninth embodiment of the present invention.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as "top," "bottom," "front," "back," etc., is used with reference to the orientation of the Figure(s) being described. The components of the present invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

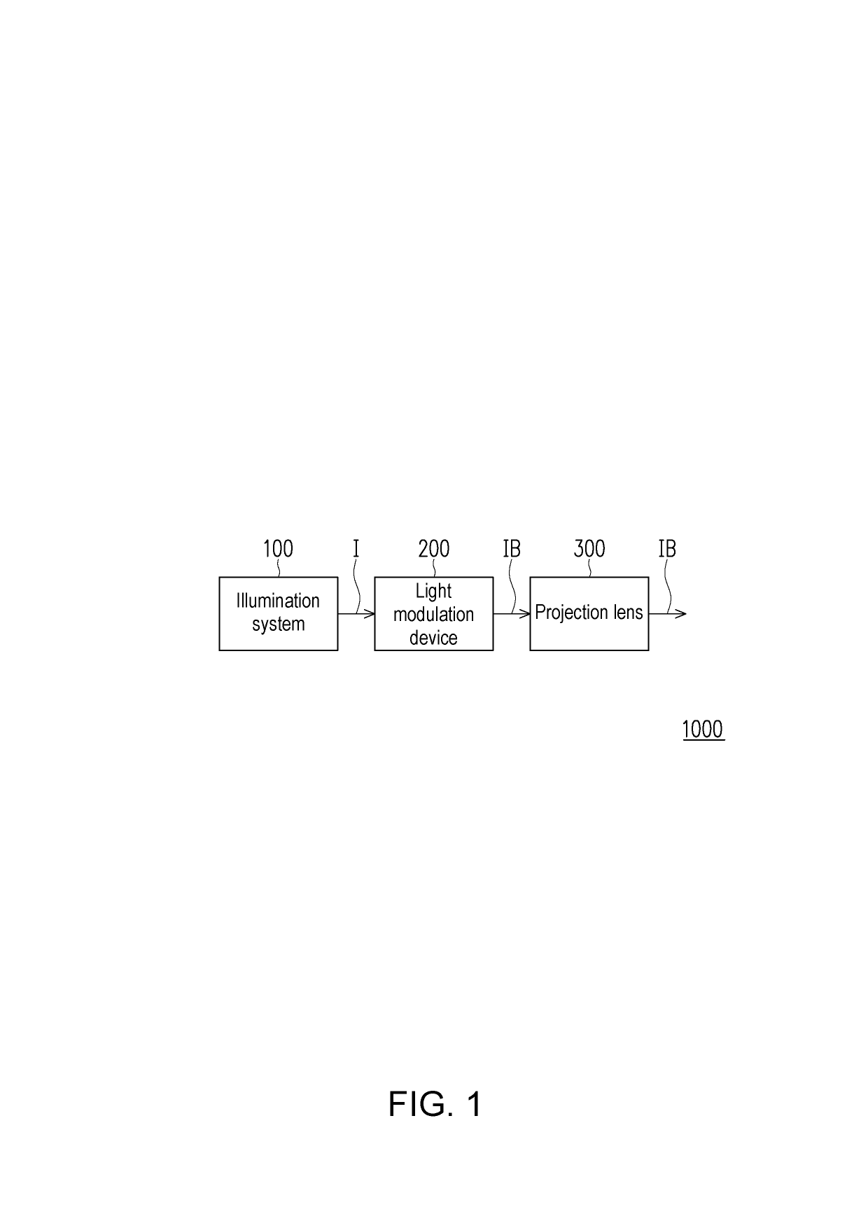

FIG. 1 is a block diagram of a projection apparatus according to an embodiment of the present invention. Referring to FIG. 1, an embodiment of the present invention provides a projection apparatus 1000. The projection apparatus 1000 includes an illumination system 100, a light modulation device 200, and a projection lens 300. The illumination system 100 is configured to provide an illumination beam I. The light modulation device 200 is disposed on a transmission path of the illumination beam I and includes at least one light valve for converting the illumination beam I into an image beam IB. The projection lens 300 is disposed on the transmission path of the image beam IB to project the image beam IB out of the projection apparatus 1000.

Specifically, in this embodiment, the light valve of the light modulation device 200 is, for example, a reflective light modulator such as a digital micro-mirror device (DMD) or a liquid-crystal-on-silicon panel (LCOS). In other embodiments, the light valve may also be a transparent liquid crystal panel, a transmissive liquid crystal panel such as an electro-optical modulator, a magneto-optic modulator, an acousto-optic modulator (AOM) or other types of spatial light modulators (SLM). The projection lens 300 includes, for example, a combination of one or more optical lenses with diopter, such as various combinations of non-planar lenses such as biconcave lenses, biconvex lenses, meniscus lenses, convex-concave lenses, plano-convex lenses, and plano-concave lenses. The present invention does not limit the form and type of the light modulation device 200 and the projection lens 300.

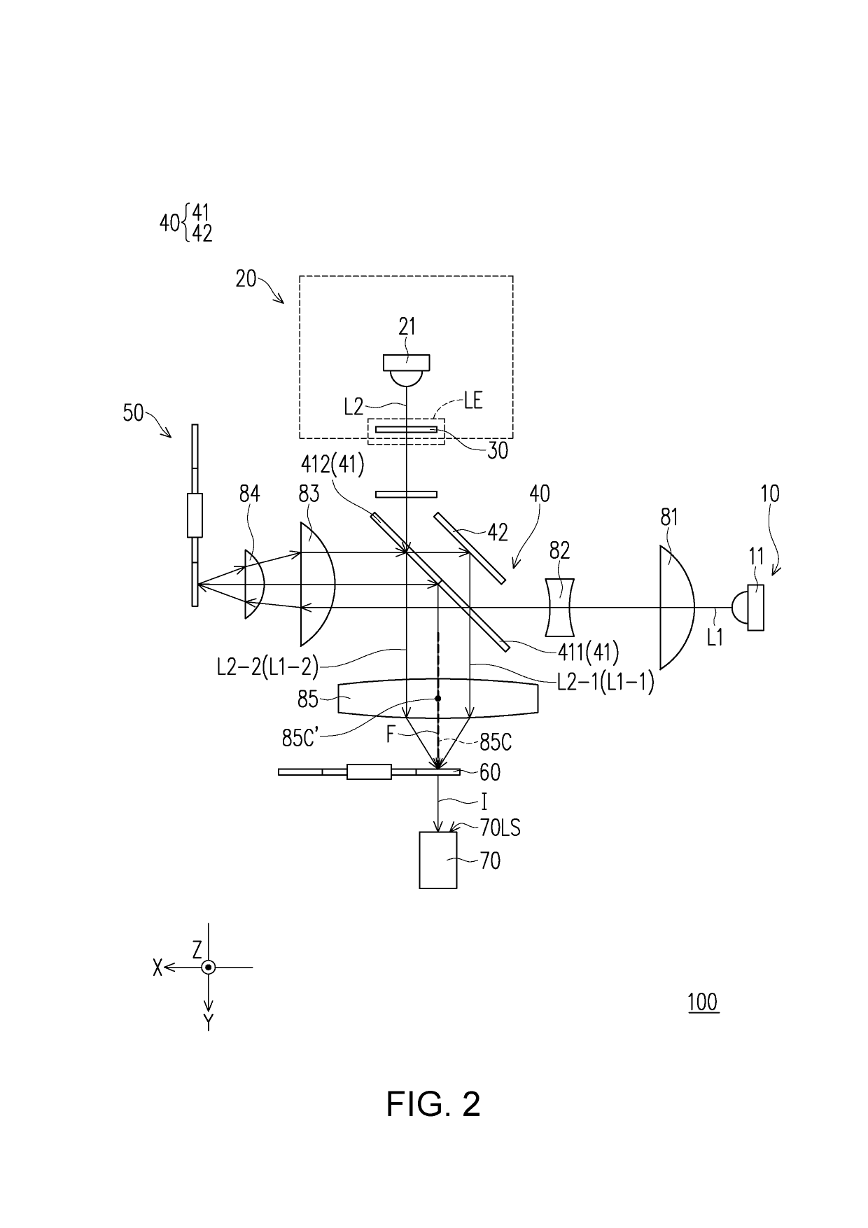

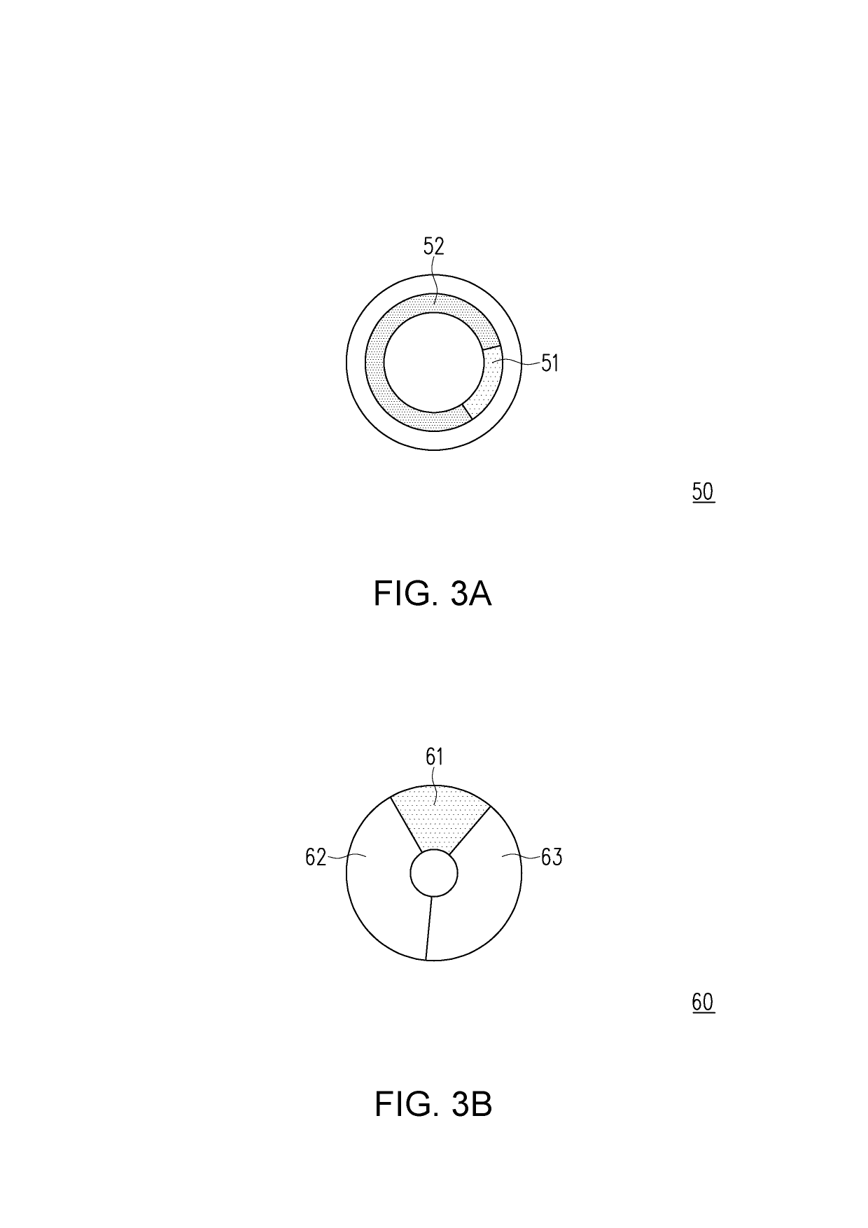

FIG. 2 is a schematic diagram of an illumination system and its optical path of a first embodiment of the present invention. FIG. 3A is a schematic diagram of a wavelength conversion device in the illumination system according to the first embodiment of the present invention. FIG. 3B is a schematic diagram of a filtering device in the illumination system according to the first embodiment of the present invention.

Referring to FIG. 2, in this embodiment, the illumination system 100 includes a first light source module 10, a second light source module 20, a light splitting and combining module 40, a condensing lens 85, a wavelength conversion device 50, and a filtering device 60. The first light source module 10 is configured to provide a first laser beam L1. The second light source module 20 is configured to provide a second laser beam L2, and a wavelength range of the first laser beam L1 does not overlap with a wavelength range of the second laser beam L2. The second light source module 20 has a light outlet, and the second laser beam L2 is emitted from the light outlet of the second light source module 20 and leaves the second light source module 20. In some embodiments, the second light source module 20 includes a filter element 30 disposed at a light outlet for allowing the second laser beam L2 to pass through and filtering out light beams of other wavelengths.

The first light source module 10 may include at least one first light source unit 11, and the first light source unit 11 is configured to provide a first laser beam L1. The second light source module 20 may include at least one second light source unit 21, and the at least one second light source unit 21 is configured to provide a second laser beam L2. The first light source unit 11 or the second light source unit 21 includes a substrate and at least one light-emitting diode (LED), at least one laser diode (LD), an array of LEDs, an array of laser diodes or a combination thereof disposed on the substrate. The first laser beam L1 is, for example, a blue light beam, and the second laser beam L2 is, for example, a red light beam, but the present invention is not limited thereto.

Referring to FIG. 2 and FIG. 3 together, the wavelength conversion device 50 is disposed on the optical path of the first laser beam L1, but is not located on the optical path of the second laser beam L2. The wavelength conversion device 50 is, for example, a phosphor wheel, which includes a disk and a motor (not shown) for driving the disk to rotate. The wavelength conversion device 50 has a first area 51 and a second area 52, and the first area and the second area together form a complete ring with the central axis of the substrate as the center. When the disk of the wavelength conversion device 50 rotates about the central axis, the first area 51 and the second area 52 take turns to enter the optical path of the first laser beam L1. When the first laser beam L1 is incident, the first area 51 reflects the first laser beam L1, and the second area 52 receives the first laser beam L1 and generates a converted beam F. It should be noted that, for the convenience of description, FIG. 2 illustrates the reflected first laser beam L1 and the converted beam F concurrently in the drawing. In actuality, the first area 51 and the second area 52 enter the optical path of the first laser beam L1 in different time periods, thereby generating the reflected first laser beam L1 and the converted beam F in different time periods. The wavelength range of the converted beam F at least partially overlaps with the wavelength range of the second laser beam L2. The converted beam F is, for example, a yellow light beam, but the present invention is not limited thereto. In one embodiment, the first area 51 is, for example, a blue light reflecting area or a blue light transmitting area, and the second area 52 is, for example, configured with a phosphor layer or phosphor layers of different colors.

Continue referring to FIG. 2, the light splitting and combining module 40 is disposed on the optical paths of the first laser beam L1, the second laser beam L2, and the converted beam F. The first laser beam L1 from the first light source module 10 is transmitted to the light splitting and combining module 40 along the first direction X. The second laser beam L2 from the second light source module 20 is transmitted to the light splitting and combining module 40 along the second direction Y. The first direction X is not parallel to the second direction Y. In one embodiment, the first direction X is perpendicular to the second direction Y. The light splitting and combining module 40 is configured to allow the first laser beam L1 from the first light source module 10 to pass through, and the light splitting and combining module 40 splits the first laser beam L1 from the first area 51 of the wavelength conversion device 50 into a first split beam L1-1 and a second split beam L1-2 in a time period, and transmits the first split beam L1-1 and the second split beam L1-2 to the condensing lens 85 along the second direction Y. The first split beam L1-1 and the second split beam L1-2 enter the condensing lens 85 symmetrically with respect to the central axis 85C of the condensing lens 85. The central axis 85C of the condensing lens 85 is parallel to the second direction Y. The light splitting and combining module 40 is further configured to split the second laser beam L2 from the second light source module 20 into a third split beam L2-1 and a fourth split beam L2-2 in another time period, and then transmit the third split beam L2-1 and the fourth split beam L2-2 to the condensing lens 85 along the second direction Y. The third split beam L2-1 and the fourth split beam L2-2 enter the condensing lens 85 symmetrically with respect to the central axis 85C. The light splitting and combining module 40 is further configured to change the transmission direction of the converted beam F so that the converted beam F enters the condensing lens 85 along the second direction Y.

Continue referring to FIG. 2, the condensing lens 85 is disposed between the light splitting and combining module 40 and the filtering device 60 to converge the incident first split beam L1-1 and the second split beam L1-2, the third split beam L2-1 and the fourth split beam L2-2, and the converted beam F, which are transmitted to the filtering device 60. The illumination beam I includes at least one of the following beams passing through the filtering device 60: the first split beam L1-1 and the second split beam L1-2, the third split beam L2-1 and the fourth split beam L2-2, and at least a portion of the converted beam F.

Continue referring to FIG. 2, the light splitting and combining module 40 includes a light splitting element 41 and a first reflective element 42. The light splitting element 41 includes a first light splitting area 411 and a second light splitting area 412 which are adjacent to each other. The first light splitting area 411 is configured to allow the first laser beam L1 and the second laser beam L2 to pass through. The second light splitting area 412 is configured to partially transmit and partially reflect the first laser beam L1 from the first area 51 of the wavelength conversion device 50 and the second laser beam L2 from the second light source module 20. The first light splitting area 411 and the second light splitting area 412 are both configured to reflect the converted beam F. The portion of the first laser beam L1 that passes through the second light splitting area 412 forms a first split beam L1-1, while the other portion of the first laser beam L1 that is reflected by the second light splitting area 412 forms a second split beam L1-2. The portion of the second laser beam L2 that is reflected by the second light splitting area 412 forms a third split beam L2-1, while the other portion of the second laser beam L2 that passes through the second light splitting area 412 forms a fourth split beam L2-2. The first reflective element 42 is disposed on the optical paths of the first split beam L1-1 and the third split beam L2-1 to reflect the first split beam L1-1 and the third split beam L2-1, so that the first split beam L1-1 and the third split beam L2-1 enter and pass through the first light splitting area 411 of the light splitting element 41. The second split beam L1-2 formed by reflection from the second light splitting area 412 and the first split beam L1-1 passing through the first light splitting area 411 enter the condensing lens 85 in parallel with each other. The fourth split beam L2-2 formed by passing through the second light splitting area 412 and the third split beam L2-1 formed by passing through the first light splitting area 411 enter the condensing lens 85 in parallel with each other. The converted beam F reflected by the first light splitting area 411 and the second light splitting area 412 of the light splitting element 41 enters the condensing lens 85. In this embodiment, the light splitting element 41 and the first reflective element 42 are parallel to each other, and are both not parallel to and not perpendicular to the first direction X and the second direction Y respectively. The central axis 85C of the condensing lens 85 is parallel to the second direction Y. In some embodiments, the first direction X is perpendicular to the second direction Y, and the normal direction of the light splitting element 41 and the normal direction of the first reflective element 42 form an included angle of 45 degrees with the first direction X and the second direction Y. The arrangement direction of the first light splitting area 411 and the second light splitting area 412 of the light splitting element 41 also forms an included angle of 45 degrees with the first direction X or the second direction Y.

Referring to FIG. 3B, the filtering device 60 at least includes a first filter area 61, a second filter area 62, and a third filter area 63. In one embodiment, the filtering device 60 includes a motor for driving the filtering device 60 to rotate about a central axis. The first filter area 61, the second filter area 62, and the third filter area 63 are disposed around the central axis of the filtering device 60. When the filtering device 60 rotates about the central axis, the first filter area 61, the second filter area 62, and the third filter area 63 take turns to correspond to the convergence position of the light beam emitted from the condensing lens 85 or its vicinity. The first filter area 61, the second filter area 62 and the third filter area 63 respectively enter the optical paths of the first split beam L1-1 and the second split beam L1-2, the third split beam L2-1 and the fourth split beam L2-2, and the converted beam F at different time periods. The first filter area 61 enters the optical paths of the first split beam L1-1 and the second split beam L1-2 in a time period. The first filtering wavelength range of the first filter area 61 at least partially overlaps with the wavelength range of the first laser beam L1, or, alternatively, the first filter area 61 has no filtering function and allows the first split beam L1-1 and the second split beam L1-2 to pass through directly. The second filter area 62 enters the optical paths of the third split beam L2-1 and the fourth split beam L2-2 in a time period. The second filtering wavelength range of the second filter area 62 at least partially overlaps with the wavelength range of the second laser beam L2. The third filter area 63 enters the optical path of the converted beam F in a time period. The third filtering wavelength range of the third filter area 63 at least partially overlaps with the wavelength range of the converted beam F. For example, the first filter area 61 is configured to allow blue light to pass through, the second filter area 62 is configured to allow red light to pass through and filter light of color of other wavelength ranges, and the third filter area 63 is configured to allow green light to pass through and filter light of other colors.

The working time period and optical path of the illumination system in the first embodiment will be further described below. In this embodiment, the operation of the illumination system 100 mainly includes the first to third time periods.

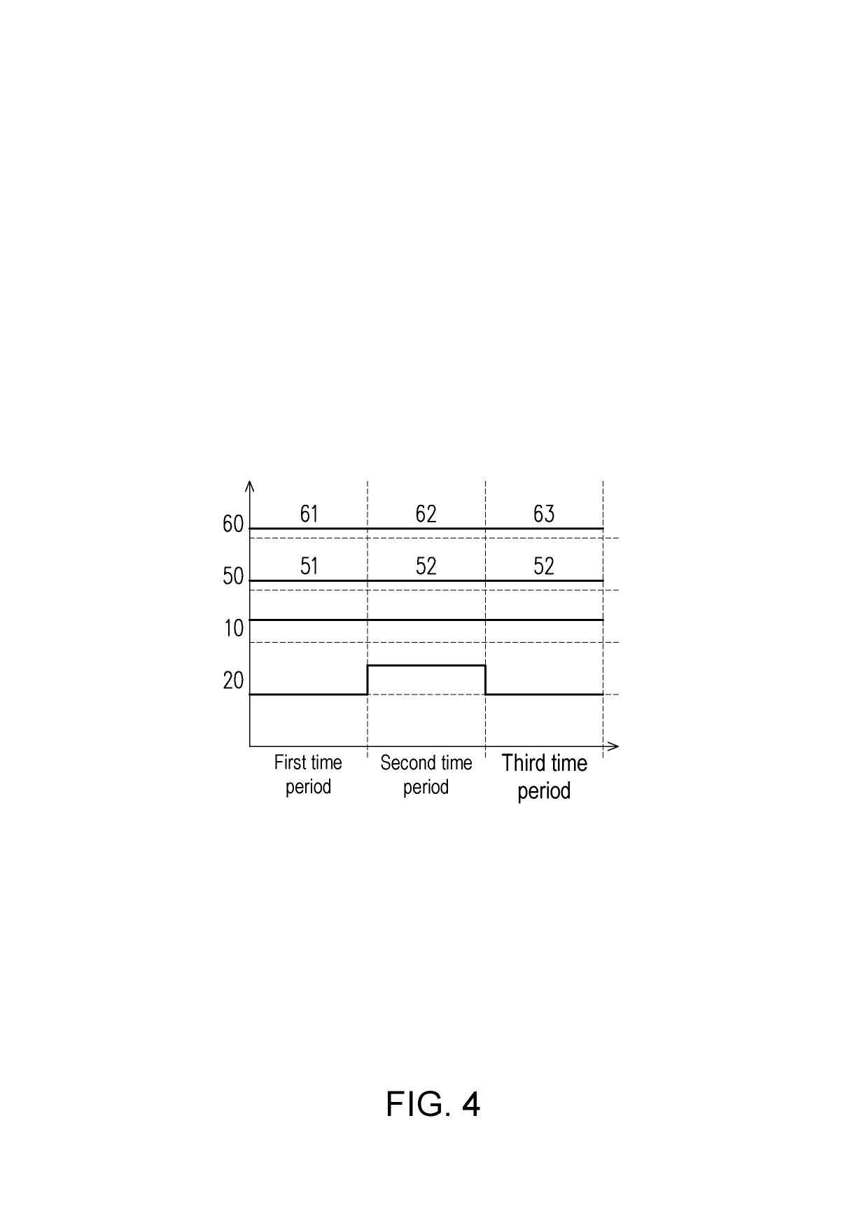

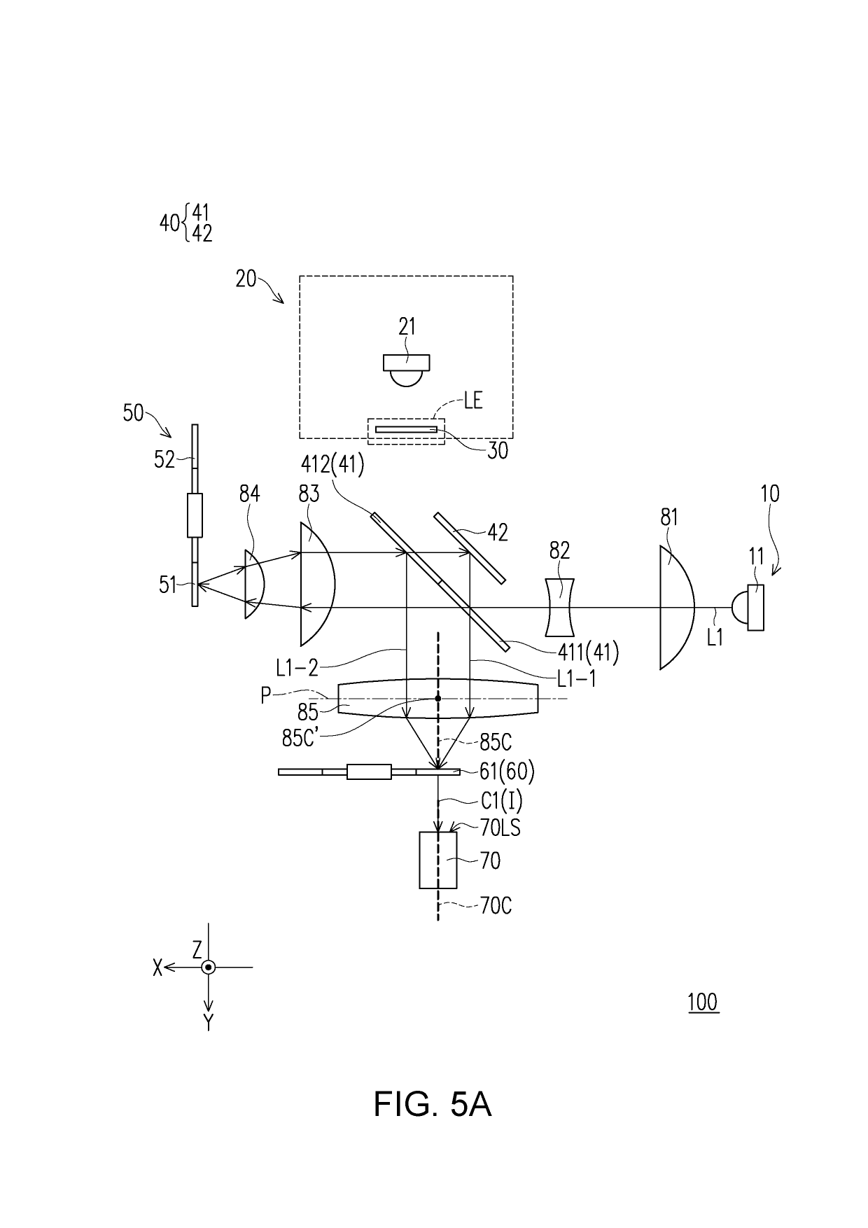

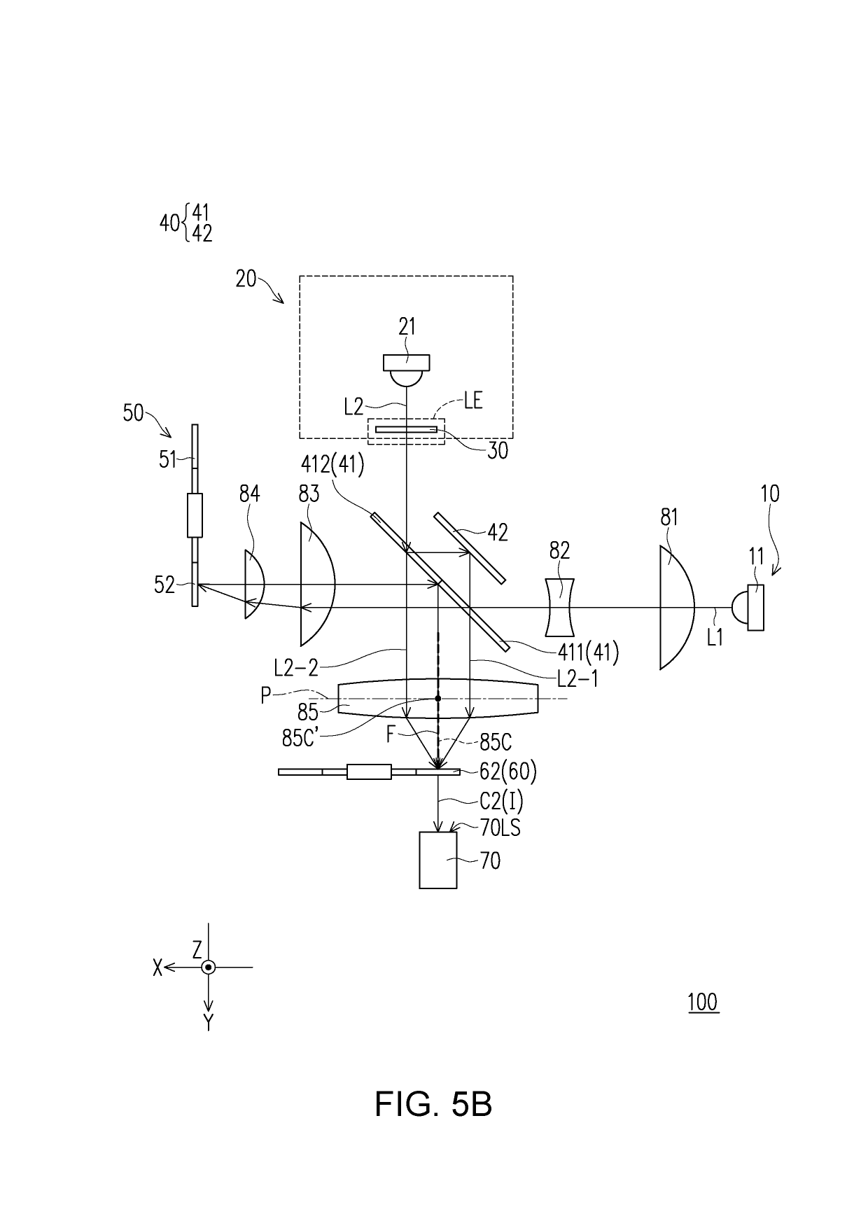

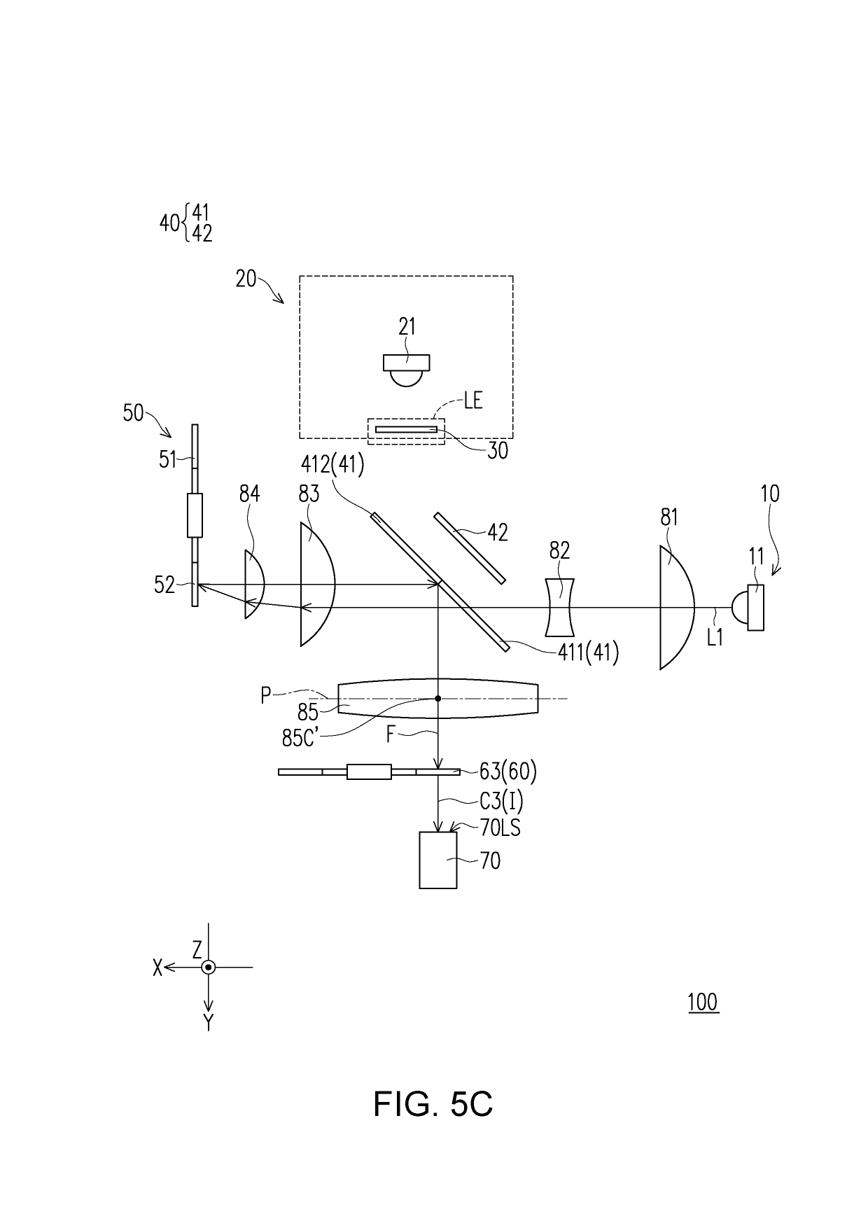

FIG. 4 is a working time period diagram of the illumination system according to the first embodiment of the present invention. FIG. 5A is a schematic diagram of an optical path of the illumination system in a first time period according to the first embodiment of the present invention. FIG. 5B is a schematic diagram of an optical path of the illumination system in a second time period according to the first embodiment of the present invention. FIG. 5C is a schematic diagram of an optical path of the illumination system in a third time period according to the first embodiment of the present invention.

Referring to FIG. 4A and FIG. 5A together, in this embodiment, the first time period, the second time period, and the third time period form a cycle. When the illumination system 100 is in operation, it loops through the cycle to sequentially provide illumination beams I of different colors. In the first time period, the first light source module 10 provides the first laser beam L1, the second light source module 20 does not provide the second laser beam L2, the first area 51 of the wavelength conversion device 50 enters the optical path of the first laser beam L1, and the first filter area 61 of the filtering device 60 enters the optical paths of the first split beam L1-1 and the second split beam L1-2. After the first laser beam L1 reflected by the first area 51 of the wavelength conversion device 50 generates the first split beam L1-1 and the second split beam L1-2 through the light splitting and combining module 40, the first split beam L1-1 and the second split beam L1-2 leaving the light splitting and combining module 40 are converged by the condensing lens 85 and enter the filtering device 60, pass through the first filter area 61 and form a first color beam C1. At the first time period, the first color beam C1 is output as the illumination beam I from the illumination system 100. The wavelength range of the first color beam C1 may be the same as or partially overlap with the wavelength range of the first laser beam L1. The first color beam C1 is, for example, a blue light beam.

Referring to FIG. 4 and FIG. 5B together, in the second time period, the first light source module 10 provides the first laser beam L1 and the second light source module 20 provides the second laser beam L2. A portion of the second area 52 of the wavelength conversion device 50 enters the optical path of the first laser beam L1, and the second filter area 62 of the filtering device 60 enters the optical paths of the converted beam F, the third split beam L2-1 and the fourth split beam L2-2. The first laser beam L1 enters the second area 52 of the wavelength conversion device 50 to generate the converted beam F which is converged by the condensing lens 85 and then enters the filtering device 60. At the same time, the second laser beam L2 generates a third split beam L2-1 and a fourth split beam L2-2 through the light splitting and combining module 40, which are then converged by the condensing lens 85 and then enter the filtering device 60. The converted light beam F, the third split beam L2-1 and the fourth split beam L2-2 pass through the second filter area 62 and generate a second color beam C2. The second color beam C2 is output as the illumination beam I from the illumination system 100. The wavelength range of the second color beam C2 may be the same as or partially overlap with the wavelength range of the second laser beam L2. The second color beam C2 is, for example, a red light beam.

Referring to FIG. 4 and FIG. 5C together, in the third time period, the first light source module 10 provides the first laser beam L1, the second light source module 20 does not provide the second laser beam L2, and the other portion of the second area 52 of the wavelength conversion device 50 enters the optical path of the first laser beam L1, thereby converting the first laser beam L1 into the converted beam F. The converted beam F is changed in direction by the light splitting and combining module 40 and enters the condensing lens 85 along the second direction Y. After being converged by the condensing lens 85, the converted beam F enters the filtering device 60. At this time, the third filter area 63 of the filtering device 60 enters the optical path of the converted beam F, the converted beam F passes through the third filter area 63 and generates a third color beam C3, which is output as the illumination beam I from the illumination system 100. The third color beam C3 is, for example, a green light beam.

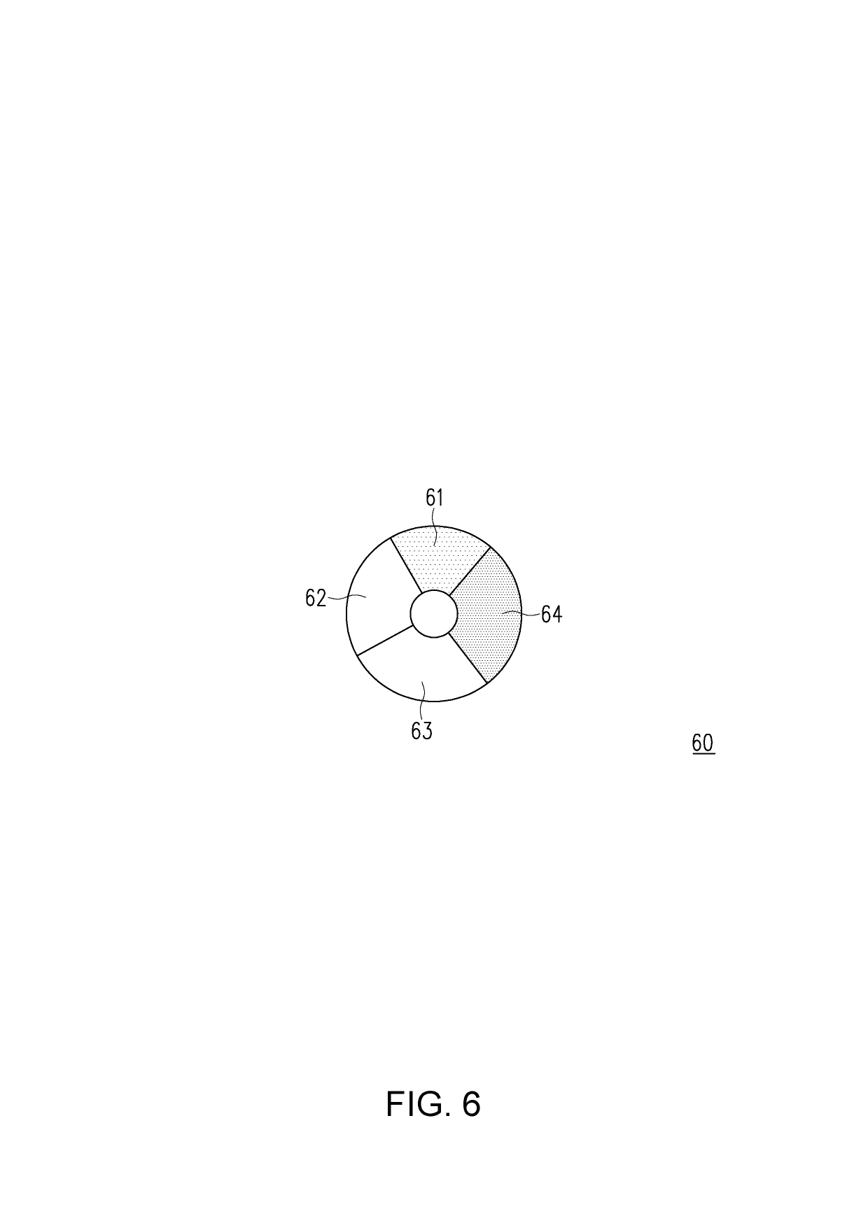

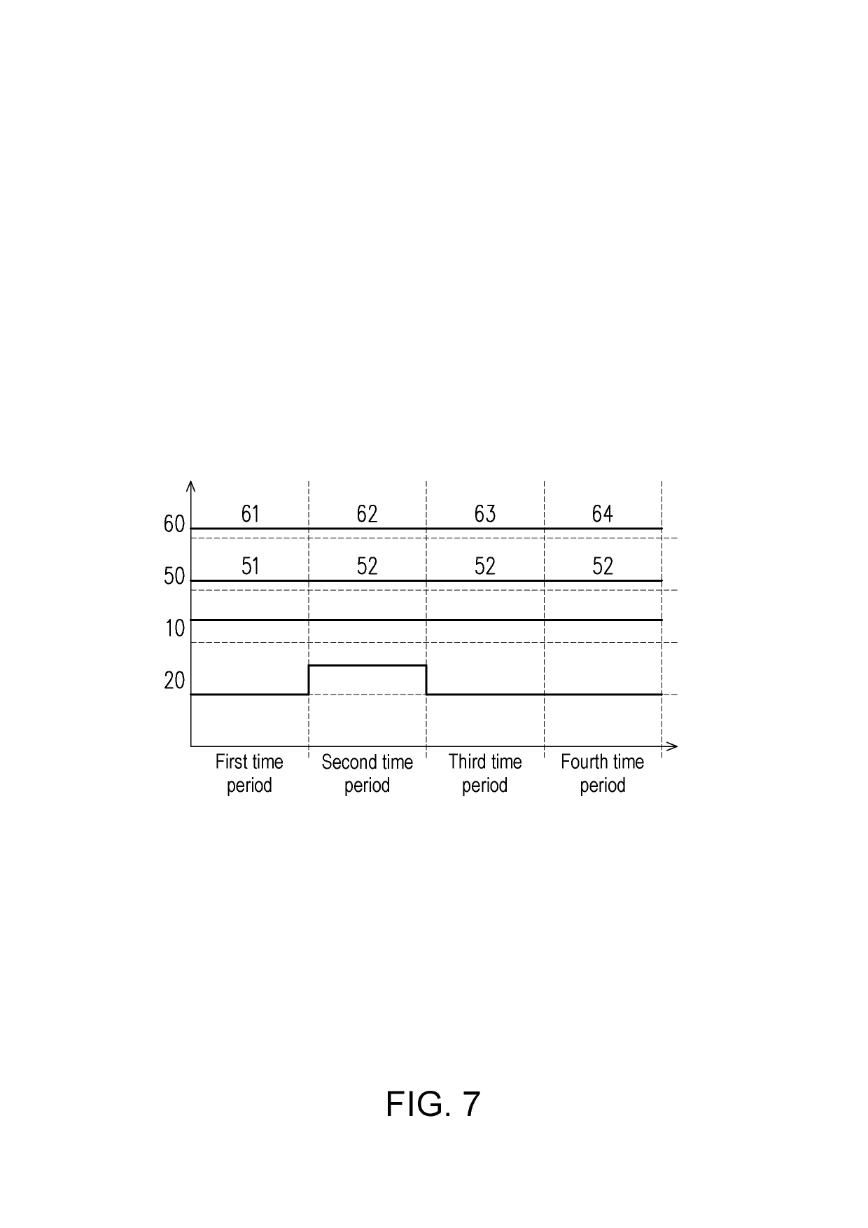

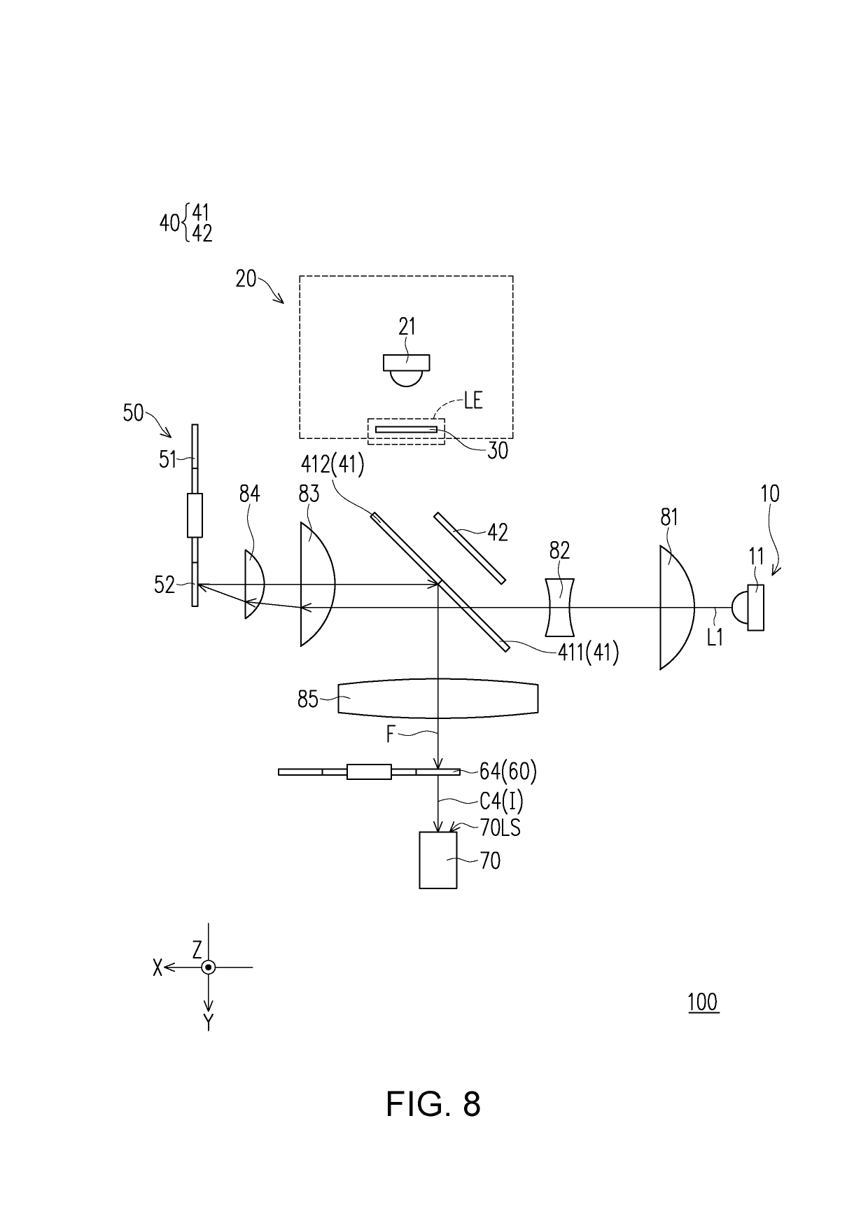

FIG. 6 is a top plan view schematic diagram of a filtering device of an illumination system according to a second embodiment of the present invention. FIG. 7 is a work time period diagram of the illumination system according to the second embodiment of the present invention. FIG. 8 is a schematic diagram of an optical path of the illumination system in a fourth time period according to the first embodiment of the present invention.

The system architecture of the second embodiment of the present invention is substantially the same as that of the first embodiment, the difference being the working time period of the illumination system further includes a fourth time period, and correspondingly, the filtering device further includes a fourth filter area 64. Since the first filter area 61 to the third filter area 63 of the filtering device in the second embodiment are the same as those in the first embodiment, and the operation methods of the first to third time periods are the same as those in the first embodiment, they are not repeated herein. The fourth filter area 64 and the fourth time period of the second embodiment are described below. In this embodiment, the first time period, the second time period, the third time period and the fourth time period form a cycle. When the illumination system 100 is in operation, it loops through the cycle to sequentially provide illumination beams I of different colors.

Referring to FIG. 6, the filtering device 60 includes the first filter area 61 to the fourth filter area 64. The fourth filtering wavelength range of the fourth filter area 64 includes the wavelength range of the second laser beam L2, and at least partially overlaps with the wavelength range of the converted beam F.

Referring to FIG. 7 and FIG. 8, in the fourth time period, the first light source module 10 generates the first laser beam L1 and the second light source module 20 does not provide the second laser beam L2. The second area 52 of the wavelength conversion device 50 enters the optical path of the first laser beam L1 and is configured to convert the first laser beam L1 into the converted beam F. The converted beam F is redirected by the light splitting and combining module 40 and enters the condensing lens 85 along the second direction Y. After being converged by the condensing lens 85, the converted beam F enters the filtering device 60. At this time, the fourth filter area 64 of the filtering device 60 enters the optical path of the converted beam F. The converted beam F passes through the fourth filter area 64 and generates a fourth color beam C4, which is output as the illumination beam I from the illumination system 100. The fourth color beam C4 is, for example, a yellow light beam, but the present invention is not limited thereto.

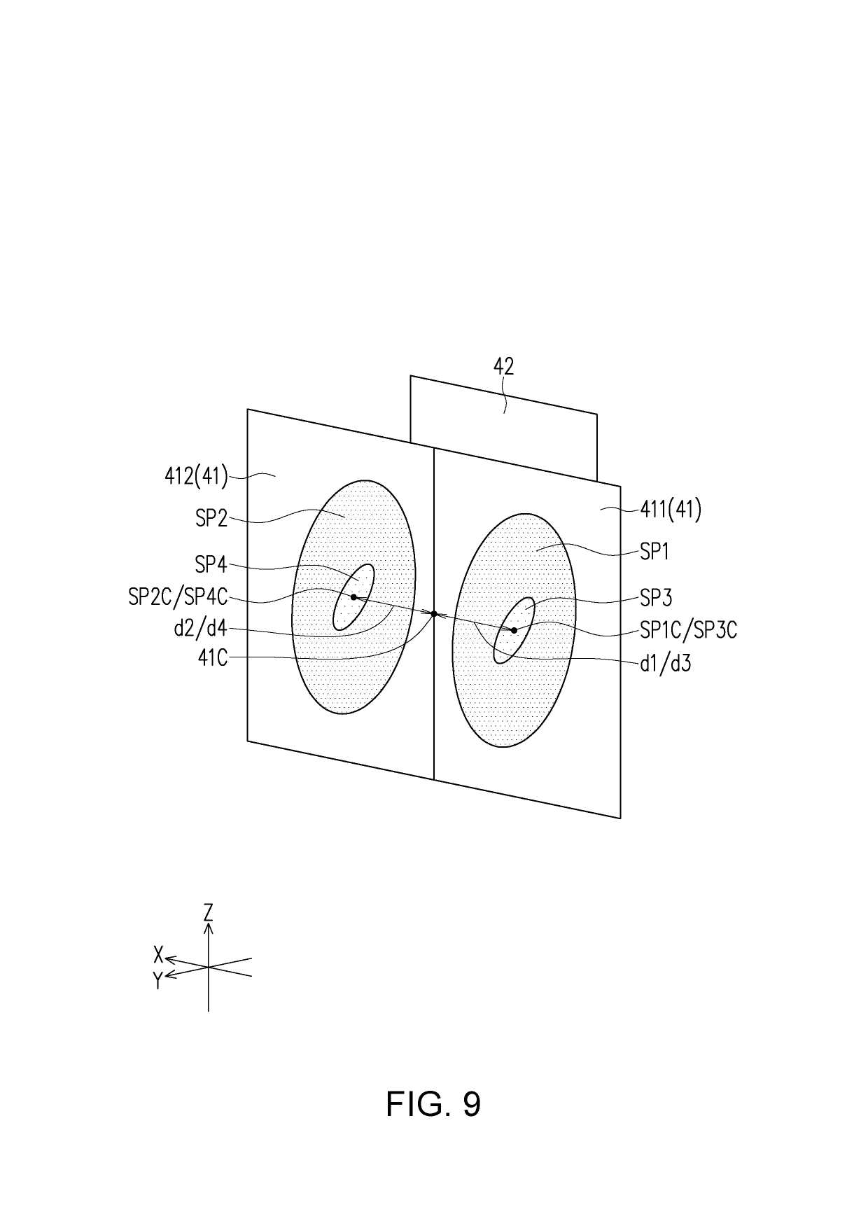

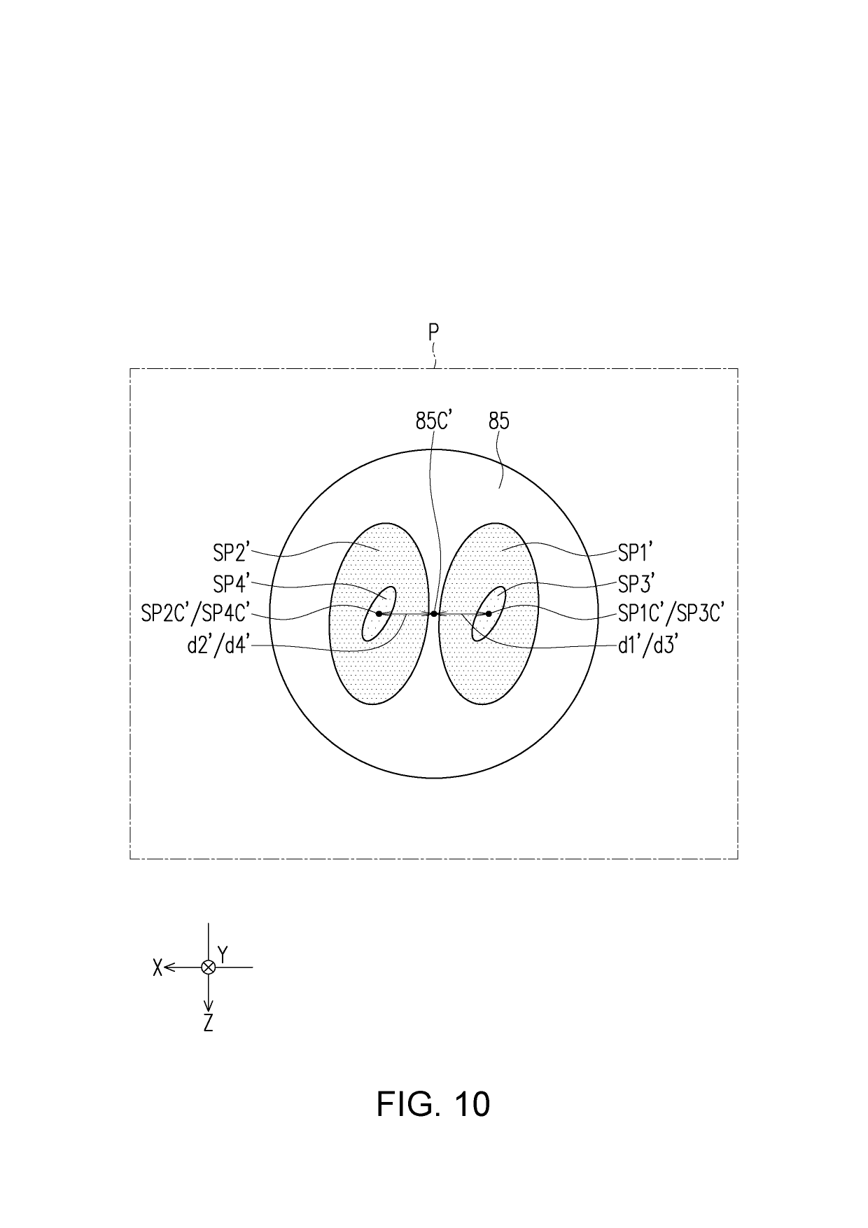

FIG. 9 is a schematic diagram of light spots formed on a light splitting element by a first laser beam and a second laser beam in the illumination system according to the first embodiment of the present invention. FIG. 10 is a schematic diagram of light spots formed on a condensing lens by a first laser beam and a second laser beam in the illumination system according to the first embodiment of the present invention.

Referring to FIG. 5A, FIG. 5B and FIG. 9, in the present embodiment, at the first time period, the first split beam L1-1 forms a light spot SP1 in the first light splitting area 411 of the light splitting element 41, and the light spot SP1 has a light spot center SP1C. The second split beam L1-2 forms a light spot SP2 in the second light splitting area 412 of the light splitting element 41, and the light spot SP2 has a light spot center SP2C. In the second time period, the third split beam L2-1 forms a light spot SP3 in the first light splitting area 411 of the light splitting element 41, and the light spot SP3 has a light spot center SP3C. The fourth split beam L2-2 forms a light spot SP4 in the second light splitting area 412 of the light splitting element 41, and the light spot SP4 has a light spot center SP4C. In one embodiment, the light spot center SP1C and the light spot center SP2C are arranged symmetrically with respect to the alignment point 41C of the light splitting element 41. The light spot center SP3C and the light spot center SP4C are arranged symmetrically with the alignment point 41C as the center. Preferably, the light spot center SP1C coincides with the light spot center SP3C, and the light spot center SP2C coincides with the light spot center SP4C.

Alternatively, in some embodiments, a distance d1 between the light spot center SP1C and the alignment point 41C is equal to a distance d3 between the light spot center SP3C and the alignment point 41C, and a distance d2 between the light spot center SP2C and the alignment point 41C is equal to a distance d4 between the light spot center SP4C and the alignment point 41C. Preferably, the distances d1, d2, d3, and d4 are equal to each other. In other embodiments, the alignment point 41C of the light splitting element 41 may be a position on the light splitting element 41 and the position need not be the center position of the light splitting element 41, provided that the alignment point 41C is located on the extension line of the central axis 85C of the condensing lens 85.

Referring to FIG. 5A, FIG. 5B and FIG. 10 together, to be more specific, as mentioned above, since the first split beam L1-1 and the second split beam L1-2, the third split beam L2-1 and the fourth split beam L2-1 enter the condensing lens 85 symmetrically with respect to the central axis of the condensing lens 85, when the first split beam L1-1 and the second split beam L1-2, the third split beam L2-1 and the fourth split beam L2-1 leaving the light splitting and combining module 40 enter the condensing lens 85, light spots with a symmetrical distribution characteristic are also formed on the condensing lens 85. Specifically, the condensing lens 85 is disposed along a reference plane P. The reference plane P is perpendicular to the central axis 85C of the condensing lens 85, and the reference plane P is perpendicular to the second direction Y. The intersection of the central axis 85C of the condensing lens 85 and the reference plane P is a center point 85C'. The first split beam L1-1 forms a first light spot SP1' on the reference plane P, and the first light spot SP1' has a first light spot center SP1C'. The second split beam L1-2 forms a second light spot SP2' on the reference plane P, and the second light spot SP2' has a second light spot center SP2C'. The third split beam L2-1 forms a third light spot SP3' on the reference plane P, and the third light spot SP3' has a third light spot center SP3C'. The fourth split beam L2-2 forms a fourth light spot SP4' on the reference plane P, and the fourth light spot SP4' has a fourth light spot center SP4C'. The first light spot center SP1C' and the second light spot center SP2C' are arranged symmetrically with respect to the center point 85C' as a center. The third light spot center SP3C' and the fourth light spot center SP4C' are arranged symmetrically with the center point 85C' as the center. Preferably, the first light spot center SP1C' overlaps with the third light spot center SP3C', and the second light spot center SP2C' overlaps with the fourth light spot center SP4C'.

Alternatively, in one embodiment, a distance d1' between the first light spot center SP1C' and the center point 85C' is equal to a distance d3' between the third light spot center SP3C' and the center point 85C', and a distance d2' between the second light spot center SP2C' and the center point 85C' is equal to a distance d4' between the fourth light spot center SP4C' and the center point 85C'. More preferably, the distances d1', d2', d3', and d4' are equal to each other.

According to the characteristics that the first split beam L1-1 and the second split beam L1-2, the third split beam L2-1 and the fourth split beam L2-1 symmetrically enter the condensing lens 85 relative to the central axis of the condensing lens 85 and that light spots with symmetrical distribution characteristics are formed, the illumination beam I formed by entering the filtering device 60 through the condensing lens 85 has a more uniform energy distribution compared to the illumination beam formed by a single laser beam, thereby enabling the image beam IB modulated by the light modulation device 200 to achieve better color accuracy.

In addition, referring to FIG. 5A to FIG. 5C and FIG. 8 again, in this embodiment, the illumination system 100 further includes a light homogenizing element 70. The light homogenizing element 70 is disposed between the filtering device 60 and the light modulation device 200, located on the transmission path of the illumination beam I, and has a light incident surface 70LS and a central axis 70C. The focal point of the condensing lens 85 is located on the light incident surface 70LS or inside the light homogenizing element 70. The central axis 70C of the light homogenizing element 70 is parallel to the optical axis (or central axis 85C) of the condensing lens 85. Accordingly, the first split beam L1-1 and the second split beam L1-2, the third split beam L2-1 and the fourth split beam L2-1, or/and the converted beam F passing through the condensing lens 85 are converged on the light incident surface 70LS of the light homogenizing element 70 or inside the light homogenizing element 70, enabling the first color beam C1 to the fourth color beam C4 generated as the illumination beam I after passing through the filtering device 60 to enter the light homogenizing element 70, so that the illumination beam I homogenized by the light homogenizing element 70 leaves the illumination system 100, and the illumination beam I leaving the illumination system 100 is transmitted to, for example, the light modulation module (device) 200 as shown in FIG. 1.

Referring to FIG. 2 again, in some embodiments, the illumination system 100 further includes lenses 81, 82, 83, and 84. The lens 81 is disposed between the first light source module 10 and the light splitting and combining module 40, and the lens 82 is disposed between the lens 81 and the light splitting and combining module 40. The lens 81 and the lens 82 are configured to collimate the first laser beam L1. The lens 81 is, for example, a condensing lens, and the lens 82 is, for example, a diverging lens. The lens 83 is disposed between the light splitting and combining module 40 and the wavelength conversion device 50, and the lens 84 is disposed between the lens 83 and the wavelength conversion device 50. The lens 83 and the lens 84 are configured to direct the first laser beam L1 from the light splitting and combining module 40 to enter a designated position of the wavelength conversion device 50, to direct the first laser beam L1 reflected from the first area 51 of the wavelength conversion device to enter the second area 412 of the light splitting element 41, and to converge the converted beam F from the second area 52 of the wavelength conversion device to the first light splitting area 411 and the second light splitting area 412 of the light splitting element 41. The lens 83 and the lens 84 are respectively, for example, condensing lenses.

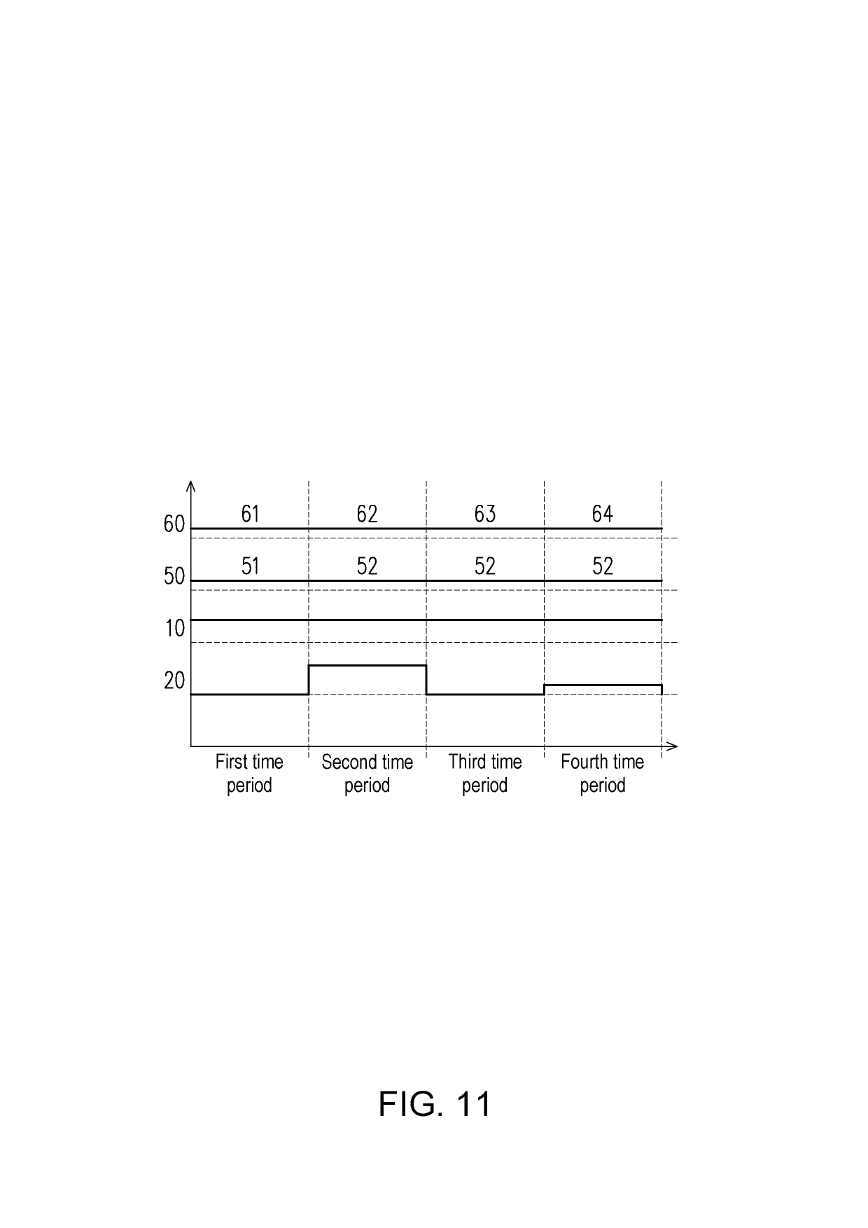

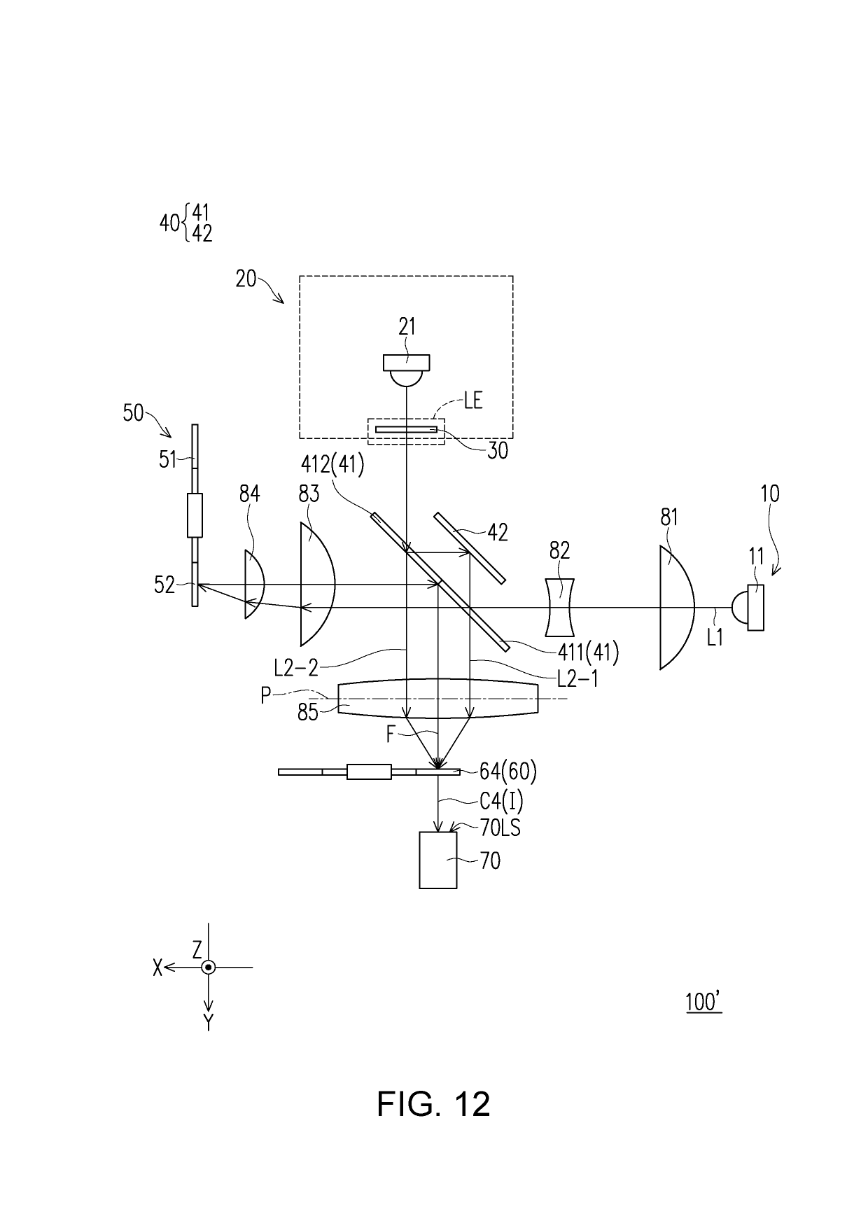

FIG. 11 is a work time period diagram in the illumination system according to the third embodiment of the present invention. FIG. 12 is a schematic diagram of an optical path of the illumination system in a fourth time period according to the third embodiment of the present invention.

The difference lies in the schematic diagram of the optical path of the illumination system of the third embodiment in the fourth time period.

Referring to FIG. 11 and FIG. 12, the illumination system 100' of the third embodiment of the present invention is substantially the same as the illumination system of the second embodiment, and the main difference is that in the fourth time period, the first light source module 10 provides the first laser beam L1, and the second light source module 20 provides the second laser beam L2. In this embodiment, the second area 52 of the wavelength conversion device 50 enters the optical path of the first laser beam L1 and is configured to convert the first laser beam L1 into the converted beam F. The converted beam F changes its transmission direction through the light splitting and combining module 40 and enters the condensing lens 85 along the second direction Y. In addition, the second laser beam L2 provided by the second light source module 20 forms a third split beam L2-1 and a fourth split beam L2-2 through the light splitting and combining module 40, and the third split beam L2-1 and the fourth split beam L2-2 enter the condensing lens 85 along the second direction Y. The converted beam F, the third split beam L2-1 and the fourth split beam L2-2 converged by the condensing lens 85 are transmitted to the filtering device 60, and at this time, the fourth filter area 64 of the filtering device 60 enters the optical paths of the converted beam F, the third split beam L2-1 and the fourth split beam L2-2, so that the converted beam F, the third split beam L2-1 and the fourth split beam L2-2 passing through the fourth filter area 64 of the filtering device 60 form an illumination beam I. Preferably, the light intensity of the second laser beam L2 in the fourth time period is less than the light intensity of the second laser beam L2 in the second time period.

That is, at the fourth time period, the illumination system turns on the first light source module 10 and the second light source module 20 simultaneously, so that the third split beam L2-1, the fourth split beam L2-2 and the converted beam pass through the fourth filter area 64 simultaneously, thereby resulting in a higher brightness of the output fourth color beam C4. Taking the above example where the second laser beam L2 is red light and the fourth color beam C4 of the illumination beam I is yellow light, the fourth filter area 64 of the filtering device 60 is a yellow filter area. At this time, the third split beam L2-1 and the fourth split beam L2-2 of red light serve as supplementary light in the red light wavelength range of the fourth color beam C4 of yellow light, thereby enhancing the brightness of the fourth color beam C4 serving as the illumination beam I. Compared with the second time period in which the red light serves as the illumination beam I, which may supplement a stronger second laser beam L2, in the fourth time period, the light intensity of the second laser beam L2 may be reduced, thereby increasing the brightness of the fourth color beam C4 while maintaining the accuracy of the light color of the fourth color beam C4.

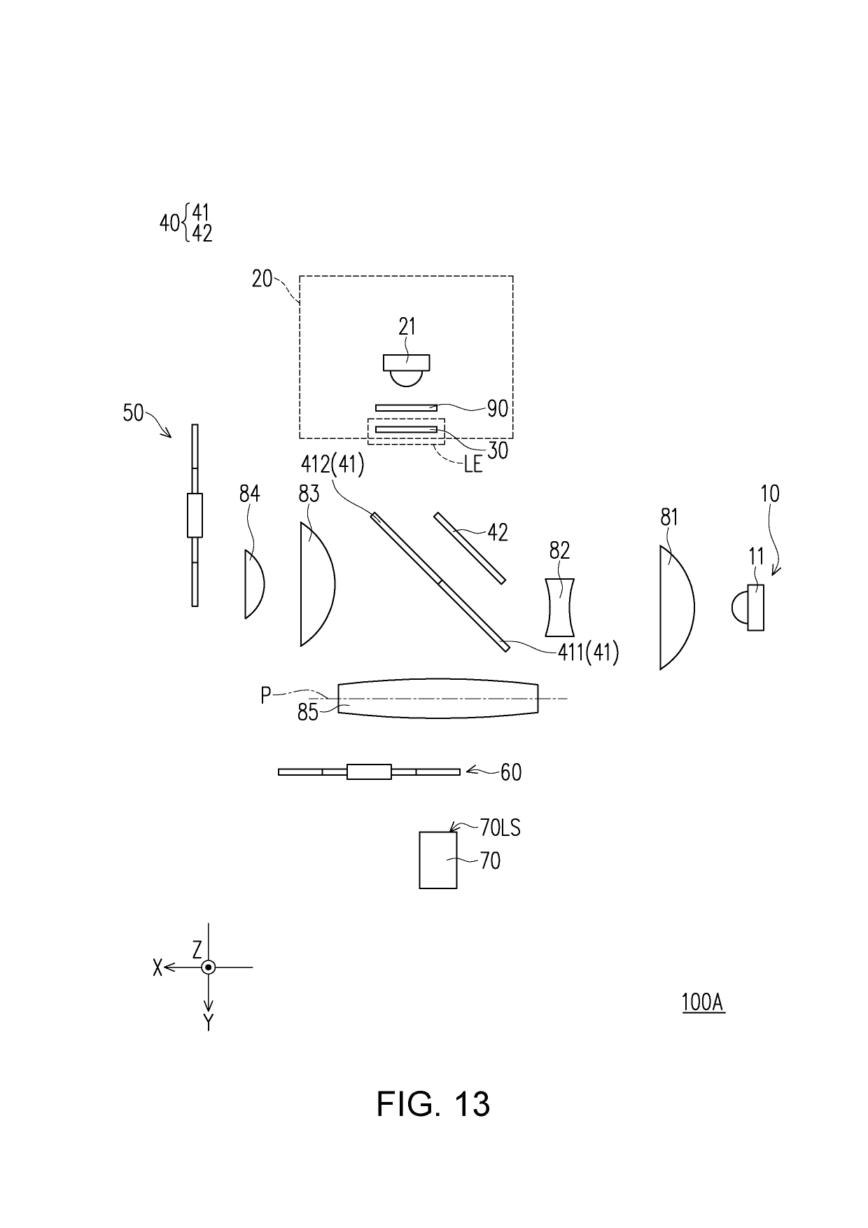

FIG. 13 is a schematic diagram of an illumination system according to a fourth embodiment of the present invention.

Referring to FIG. 13, the illumination system 100A of the fourth embodiment of the present invention has substantially the same structure as the illumination system of the first to third embodiments. The main difference is that the second light source module 20 of the illumination system 100A of the third embodiment further includes a light diffusion element 90. The light diffusion element 90 is configured to expand or homogenize the second laser beam L2. In this embodiment, the light diffusion element 90 is, for example, a diffuser, and the light diffusion element 90 and the filter element 30 are two separately configured elements, but the present invention is not limited thereto. The second laser beam L2, after passing through the light diffusion element 90 of the second light source module 20, is emitted from the second light source module 20 and enters the light splitting and combining module 40. The second laser beam L2, after passing through the light diffusion element 90 and the filter element 30 of the second light source module 20 in sequence, is emitted from the second light source module 20 and enters the light splitting and combining module 40.

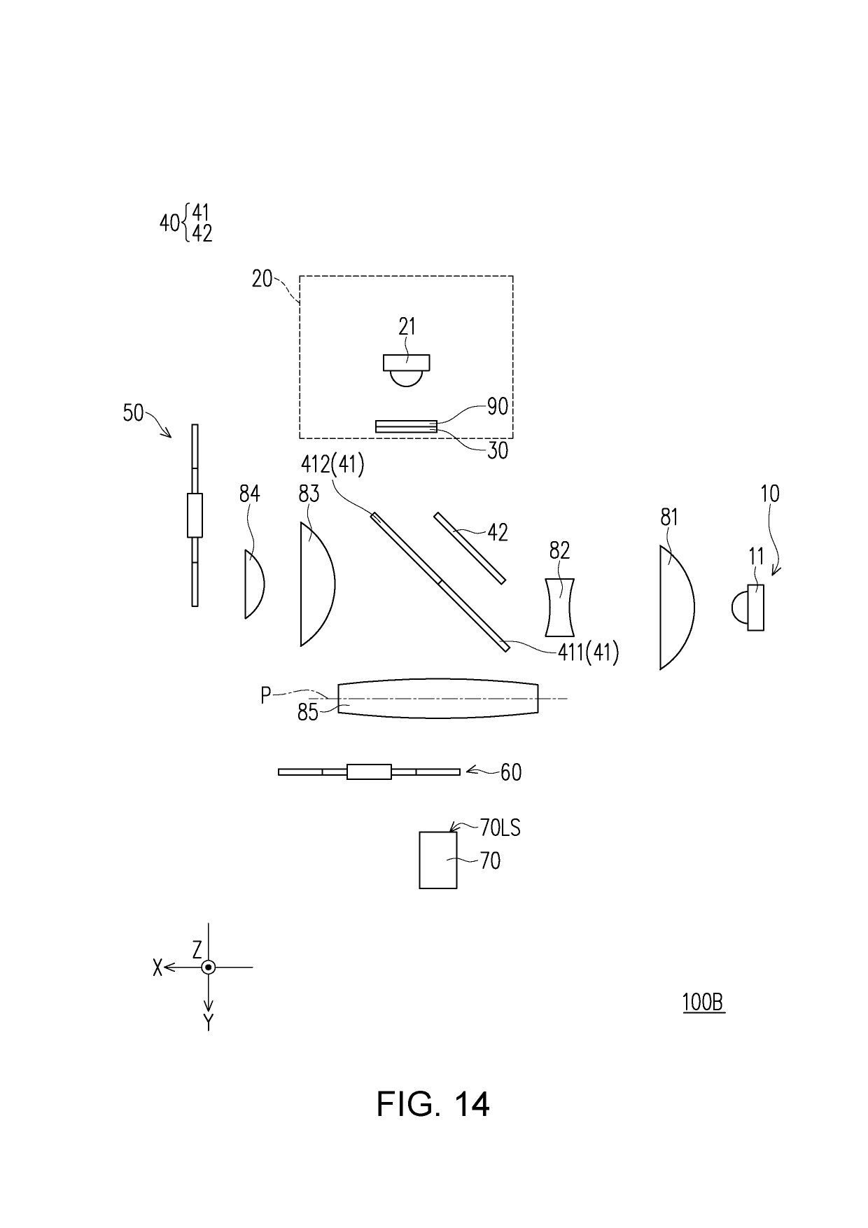

FIG. 14 is a schematic diagram of an illumination system 100B according to a fifth embodiment of the present invention. Referring to FIG. 14, the illumination system 100B is substantially the same as the illumination system 100A of the fourth embodiment. The main difference is that in this embodiment, the filter element 30 is a filter film disposed on the light diffusion element 90.

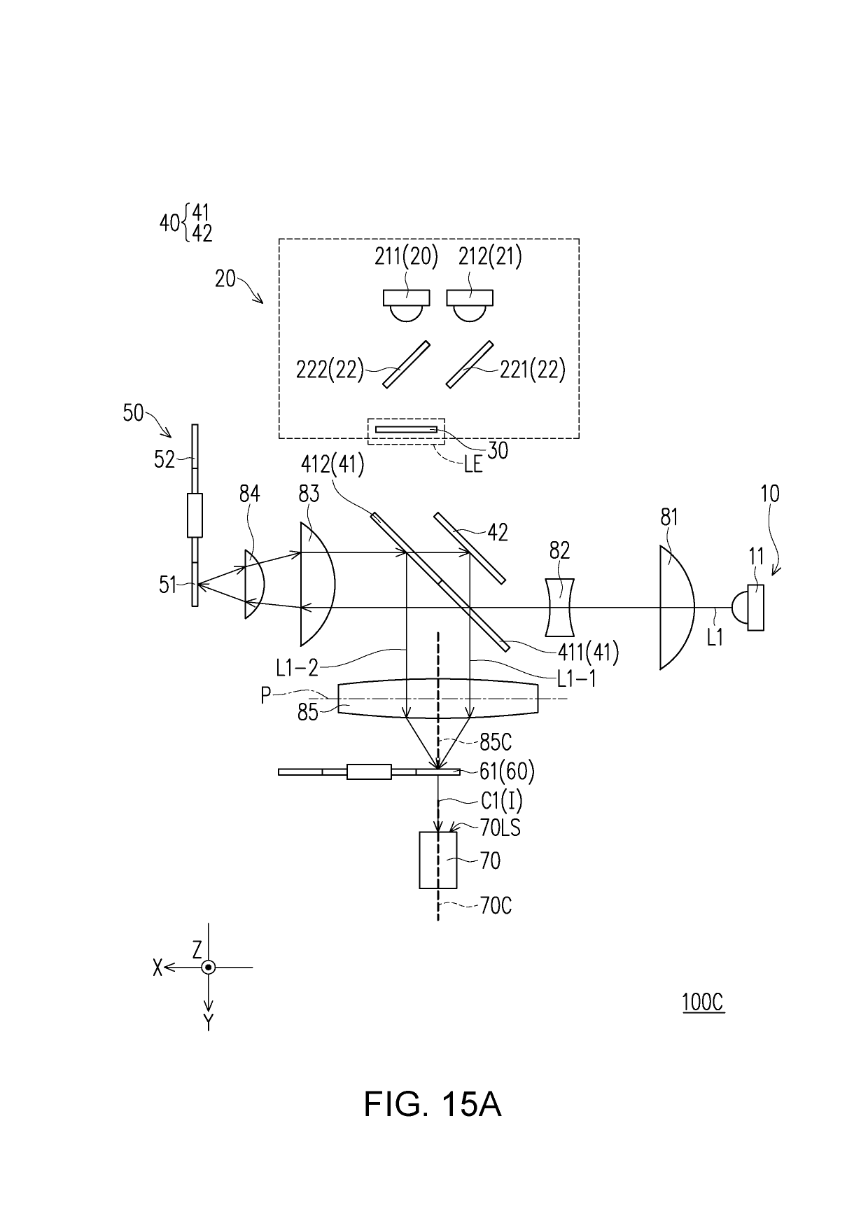

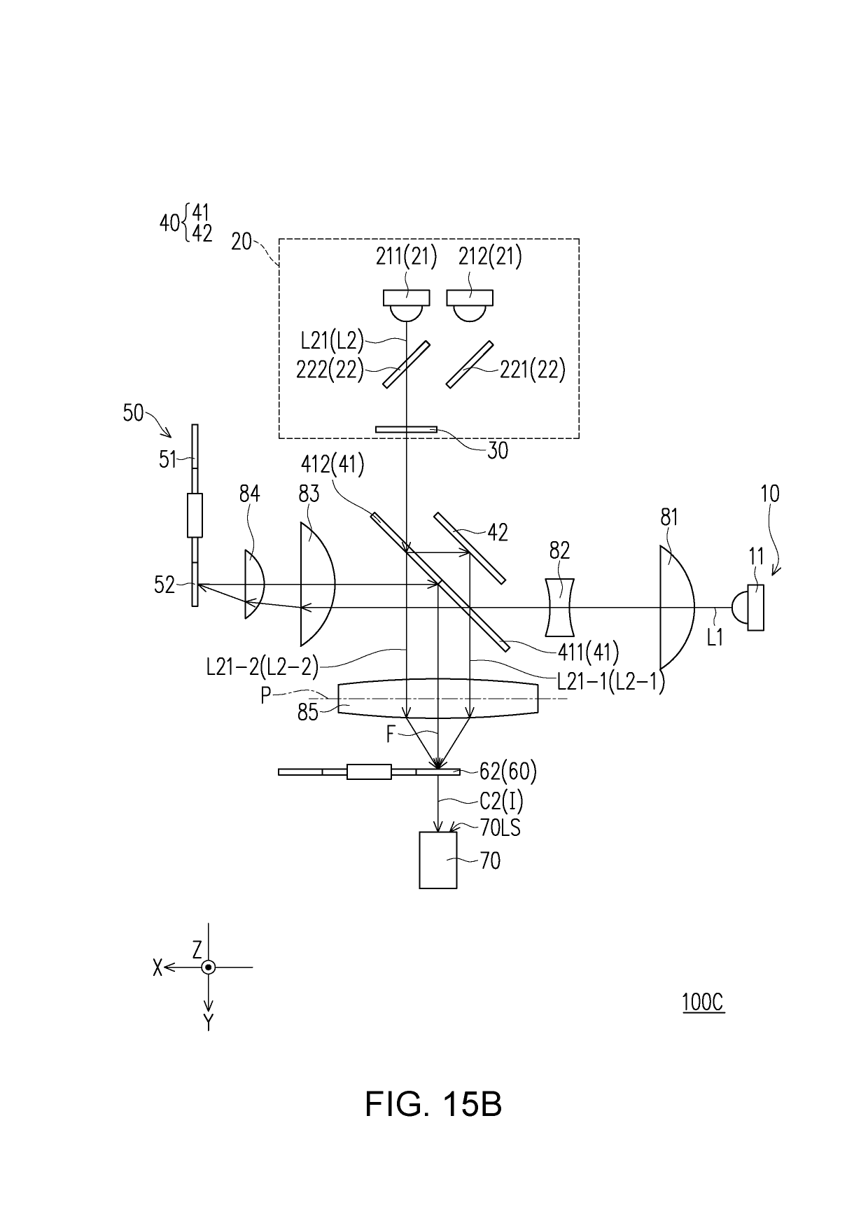

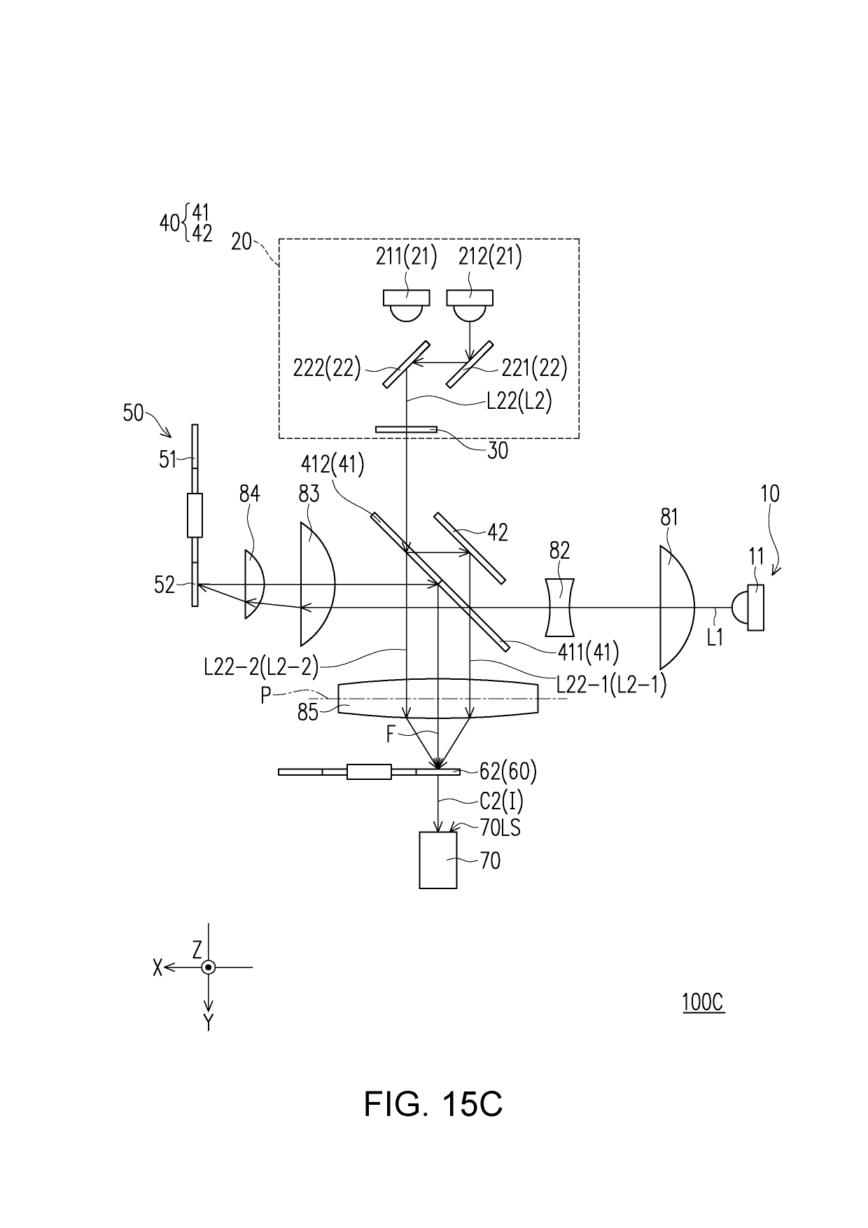

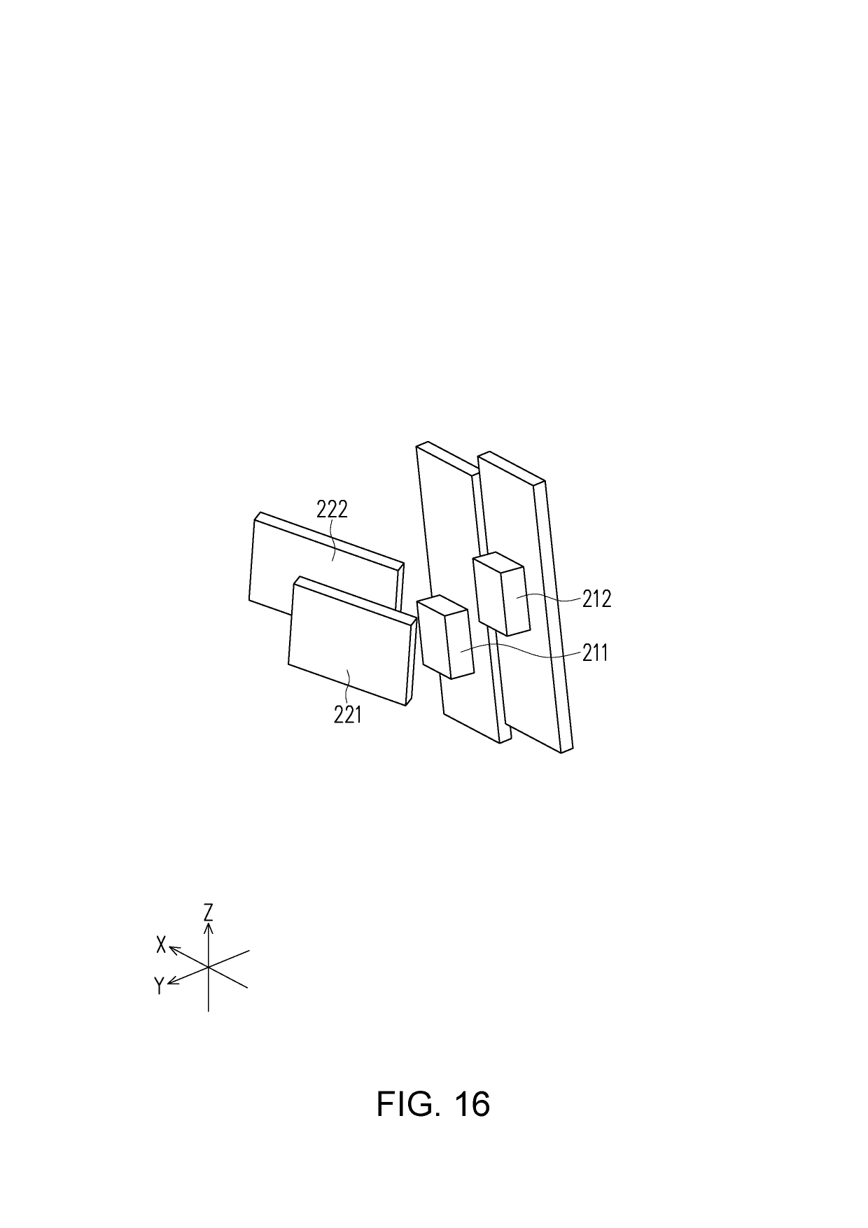

FIG. 15A is a schematic diagram of an optical path of the first laser beam of the illumination system in the first time period according to a sixth embodiment of the present invention. FIG. 15B is a schematic diagram of an optical path corresponding to a first sub-light beam of the illumination system in the second time period according to the sixth embodiment of the present invention. FIG. 15C is a schematic diagram of an optical path corresponding to a second sub-light beam of the illumination system in the second time period according to the sixth embodiment of the present invention. FIG. 16 is a three-dimensional schematic diagram of a portion of the elements of a second light source module of the illumination system according to the sixth embodiment of the present invention.

Referring to FIG. 15A to FIG. 15C, the illumination system 100C of the sixth embodiment is substantially the same as the illumination system 100 of the first embodiment and the second embodiment, and the working time period is also the same. The main difference is that the second light source module 20 includes at least one second light source unit 21 and a light guide assembly 22. The at least one second light source unit 21 includes a first sub-light source unit 211 and a second sub-light source unit 212.

Referring to FIG. 15A, the optical path of the first laser beam L1 in the first time period in the sixth embodiment is the same as the optical path of the first laser beam L1 in the first time period in the first embodiment, and thus is not repeated herein.

Referring to FIG. 15B, FIG. 15C and FIG. 16, the first sub-light source unit 211 and the second sub-light source unit 212 respectively include a substrate and a light-emitting element disposed on the substrate. The light-emitting element is, for example, at least one light-emitting diode (LED), at least one laser diode (LD), or a combination thereof. In this embodiment, the first sub-light source unit 211 is configured to provide a first sub-light beam L21. The second sub-light source unit 212 is configured to provide a second sub-light beam L22. The wavelength ranges of the first sub-light beam L21 and the second sub-light beam L22 are the same. The light guide assembly 22 is disposed on the transmission path of the second sub-light beam L22 and is configured to guide the transmission paths of the first sub-light beam L21 and the second sub-light beam L22 to coincide with each other in the orthographic projection of the plane formed by the first direction X and the second direction Y and to transmit along the second direction Y. In other words, the first sub-light beam L21 and the second sub-light beam L22 leaving the light guide assembly 22 are offset in a third direction Z. The first direction X, the second direction Y, and the third direction Z are perpendicular to each other. The second laser beam L2 includes a first sub-light beam L21 provided by the first sub-light source unit 211 and a second sub-light beam L22 leaving from the light guide assembly 22.

Referring to FIG. 16, in one embodiment, the setting positions of the first sub-light source unit 211 and the second sub-light source unit 212 coincide in the second direction Y, but does not coincide in the first direction X and the third direction Z. In other words, the orthographic projection positions of the setting positions of the first sub-light source unit 211 and the second sub-light source unit 212 on an axis parallel to the second direction Y overlap. The orthographic projections of the first sub-light source unit 211 and the second sub-light source unit 212 on the plane formed by the second direction Y and the third direction Z do not overlap, and the orthographic projections on the plane formed by the first direction X and the third direction Z do not overlap. The light guide assembly 22 includes a second reflective element 221 and a third reflective element 222. The second reflective element 221 is disposed corresponding to the second sub-light source unit 212 in the third direction Z and the first direction X, that is, the orthographic projections of the setting positions of the second reflective element 221 and the second sub-light source unit 212 on a plane formed by the first direction X and the third direction Z overlap. The third reflective element 222 corresponds to the optical path of the second sub-light beam L22 emitted by the second sub-light source unit 212 in the third direction Z. The orthographic projections of the third reflective element 222 and the first reflective element 42 on the plane formed by the second direction Y and the third direction overlap, and the third reflective element 222 is disposed corresponding to the first sub-light source unit 211 in the first direction X, that is, the orthographic projections of the setting positions of the third reflective element 222 and the first sub-light source unit 211 on an axis parallel to the first direction X overlap with each other. The second sub-light beam L22 provided by the second sub-light source unit 212 is first reflected by the second reflective element 221 and then transmitted to the third reflective element 222 along the first direction X. Then, the second sub-light beam L22 is reflected by the third reflective element 222 and then leaves the light guide assembly 22 along the second direction Y. When the second light source module 20 is turned on, the first sub-light source unit 211 and the second sub-light source unit 212 are turned on at the same time. Accordingly, the second laser beam L2 leaving the second light source module 20 includes the first sub-light beam L21 and the second sub-light beam L22 transmitted along the second direction Y and offset in the third direction Z.

As shown in FIG. 15B, the first sub-light beam L21 provided by the first sub-light source unit 21 of the second light source module 20 does not pass through the light guide assembly 22 but directly leaves from the light outlet of the second light source module 20 and enters the light splitting and combining module 40. The second light splitting area 412 of the light splitting element 41 of the light splitting and combining module 40 is configured is configured to partially transmit and partially reflect the first sub-light beam L21. The portion of the first sub-light beam L21 that passes through the second light splitting area 412 forms a light beam L21-2 and continues to be transmitted to the condensing lens 85. The other portion of the first sub-light beam L21 reflected by the second light splitting area 412 forms a light beam L21-1 and is transmitted to the first reflective element 42, passes through the first light splitting area 411 of the light splitting element 41 after being reflected by the first reflective element 42, and then transmitted to the condensing lens 85.

As shown in FIG. 15C, the second sub-light beam L22 provided by the second sub-light source unit 212 of the second light source module 20 changes its transmission path through the light guide assembly 22, leaves the light outlet of the second light source module 20 and enters the light splitting and combining module 40. The second light splitting area 412 of the light splitting element 41 of the light splitting and combining module 40 is configured is configured to partially transmit and partially reflect the second sub-light beam L22. The portion of the second sub-light beam L22 that passes through the second light splitting area 412 forms a light beam L21-2 and continues to be transmitted to the condensing lens 85. The other portion of the second sub-light beam L22 reflected by the second light splitting area 412 forms a light beam L22-1 and is transmitted to the first reflective element 42, passes through the first light splitting area 411 of the light splitting element 41 after being reflected by the first reflective element 42, and then transmitted to the condensing lens 85.

Accordingly, the third split beam L2-1 includes a portion of the first sub-light beam L21 (light beam L21-1) and a portion of the second sub-light beam L22 (light beam L22-1), while the fourth split beam L2-2 includes the other portion of the first sub-light beam L21 (light beam L21-2) and the other portion of the second sub-light beam L22 (light beam L22-2).

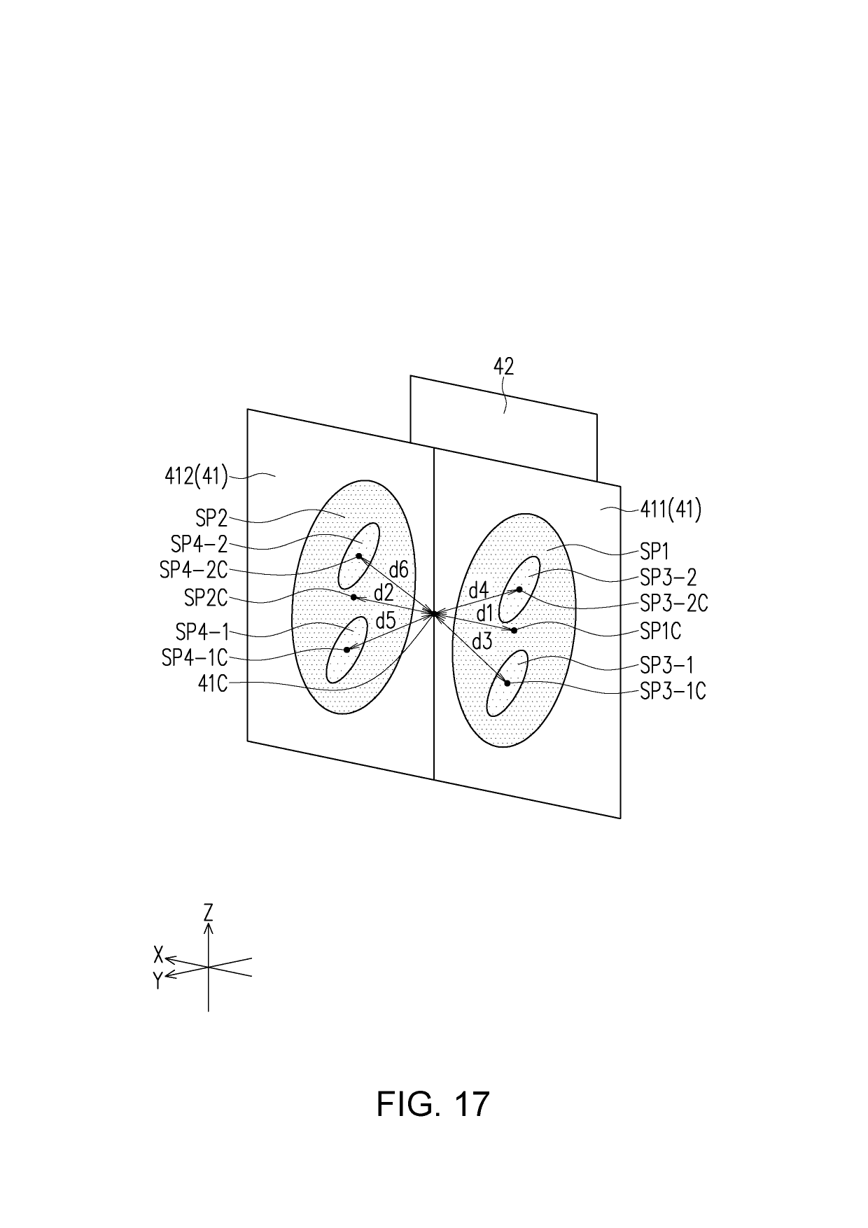

FIG. 17 is a schematic diagram of light spots formed on a light splitting element in the illumination system according to the sixth embodiment of the present invention.

Referring to FIG. 15A and FIG. 17 together, similar to the first and second embodiments, the first split beam L1-1 formed by the first laser beam L1 forms a light spot SP1 in the first light splitting area 411 of the light splitting element 41, and the light spot SP1 has a light spot center SP1C. The second split beam L1-2 formed by the first laser beam L1 forms a light spot SP2 in the second light splitting area 412 of the light splitting element 41, and the light spot SP2 has a light spot center SP2C.

Referring to FIG. 15B and FIG. 17 together, the light beam L21-1 formed by partial reflection of the first sub-light beam L21 by the second light splitting area 412 of the light splitting element 41 is reflected by the first reflective element 42 and then forms a light spot SP3-1 in the first light splitting area 411 of the light splitting element 41, and the light spot SP3-1 has a light spot center SP3-1C. The light beam L21-2 formed by the first sub-light beam L21 partially passing through the second light splitting area 412 of the light splitting element 41 forms a light spot SP4-1 in the first light splitting area 411 of the light splitting element 41, and the light spot SP4-1 has a light spot center SP4-1C.

Referring to FIG. 15C and FIG. 17 together, the light beam L22-1 formed by partial reflection of the second sub-light beam L22 by the second light splitting area 412 of the light splitting element 41 is reflected by the first reflective element 42 and then forms a light spot SP3-2 in the first light splitting area 411 of the light splitting element 41, and the light spot SP3-2 has a light spot center SP3-2C. The light beam L22-2 formed by the second sub-light beam L22 partially passing through the second light splitting area 412 of the light splitting element 41 forms a light spot SP4-2 in the second light splitting area 412 of the light splitting element 41, and the light spot SP4-2 has a light spot center SP4-2C.

A distance d1 between the light spot center SP1C and an alignment point 41C of the light splitting element 41 is equal to a distance d2 between the light spot center SP2C and the alignment point 41C. A distance d3 between the light spot center SP3-1C and the alignment point 41C, a distance d4 between the light spot center SP3-2C and the alignment point 41C, a distance d5 between the light spot center SP4-1C and the alignment point 41C, and a distance d6 between the light spot center SP4-2C and the alignment point 41C are equal to each other.

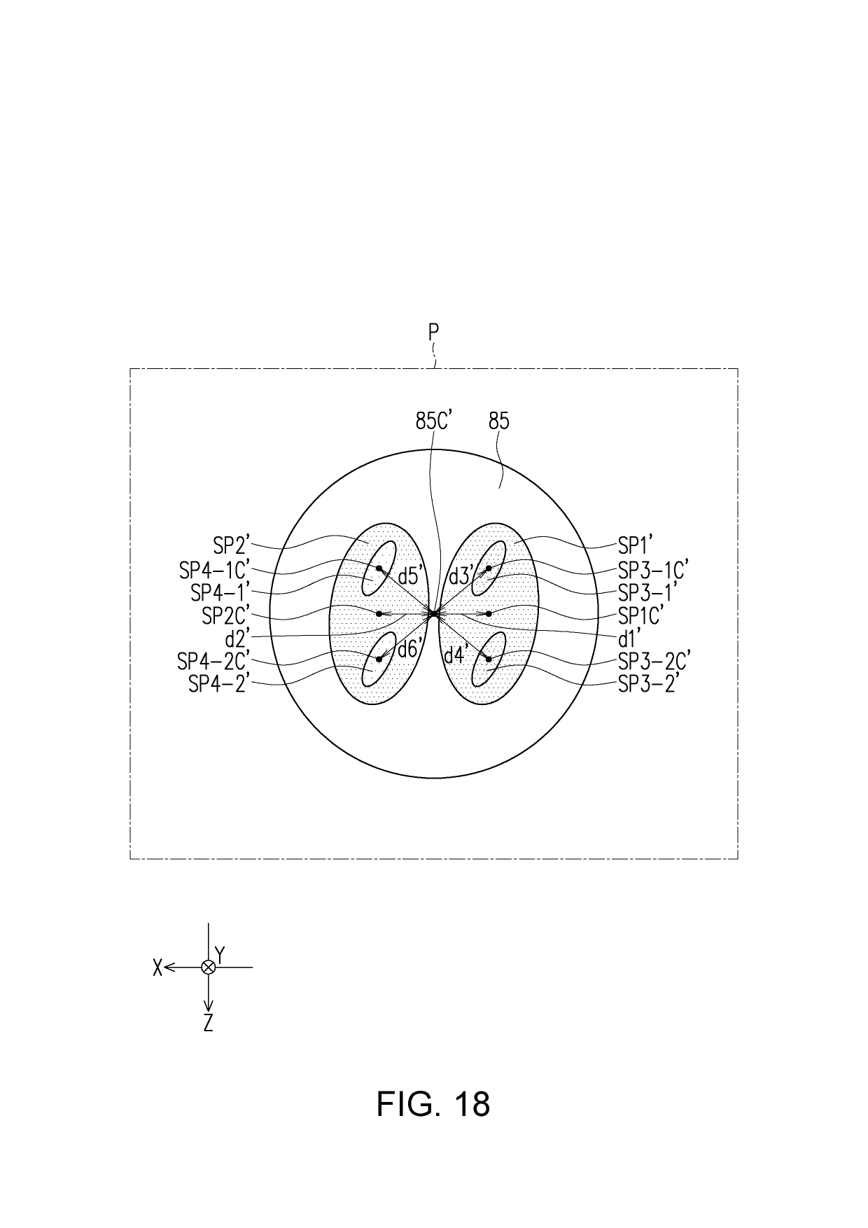

FIG. 18 is a schematic diagram of light spots formed on the condensing lens 85 by each light beam in the illumination system according to the sixth embodiment of the present invention.

Referring to FIG. 15A and FIG. 18, on the reference plane P where the condensing lens 85 is located, the first split beam L1-1 forms a first light spot SP1' on the reference plane P, and the first light spot SP1' has a first light spot center SP1C'. The second split beam L1-2 forms a second light spot SP2' on the reference plane P, and the second light spot SP2' has a second light spot center SP2C'.

Referring to FIG. 15B, FIG. 15C, and FIG. 18 together, a portion of the first sub-light beam L21 (light beam L21-1) in the third split beam L2-1 forms a first sub-light spot SP3-1' on the reference plane P. The first sub-light spot SP3-1' has a first sub-light spot center SP3-1C'. A portion of the second sub-light beam L22 (light beam L22-1) in the third split beam L2-1 forms a second sub-light spot SP3-2' on the reference plane P. The second sub-light spot SP3-2' has a second sub-light spot center SP3-2C'. The other portion of the first sub-light beam L21 (light beam L21-2) in the fourth split beam L2-2 forms a third sub-light spot SP4-1' on the reference plane P. The third sub-light spot SP4-1' has a third sub-light spot center SP4-1C'. The other portion of the second sub-light beam L22 (light beam L22-2) in the fourth split beam L2-2 forms a fourth sub-light spot SP4-2' on the reference plane P. The fourth sub-light spot SP4-2' has a fourth sub-light spot center SP4-2C'.

Preferably, the first light spot center SP1C' and the second light spot center SP2C' are arranged symmetrically relative to the center point 85C' of the condensing lens 85, and the first sub-light spot center SP3-1C' to the fourth sub-light spot center SP4-2C' are arranged symmetrically relative to the center point 85C' of the condensing lens 85.

Specifically, a distance d1' between the first light spot center SP1C' and the center point 85C' of the condensing lens 85 is equal to a distance d2' between the second light spot center SP2C' and the center point 85C'. A distance d3' between the first sub-light spot center SP3-1C' and the center point 85C', a distance d4' between the second sub-light spot center SP3-2C' and the center point 85C', a distance d5' between the third sub-light spot center SP4-1C' and the center point 85C', and a distance d6' between the fourth sub-light spot center SP4-2C' and the center point 85C' are equal to each other.

The first sub-light spot SP3-1' and the second sub-light spot SP3-2' are respectively formed by the first sub-light beam L21 and the second sub-light beam L22, and the third sub-light spot SP4-1' and the fourth sub-light spot SP4-2' are respectively formed by the first sub-light beam L21 and the second sub-light beam L22. Therefore, when the first sub-light beam L21 and the second sub-light beam L22 are respectively transmitted on the plane formed by the first direction X and the second direction Y, the misalignment distance of the first sub-light spot SP3-1' and the second sub-light spot SP3-2' in the third direction Z and the misalignment distance of the third sub-light spot SP4-1' and the fourth sub-light spot SP4-2' in the third direction Z may be adjusted by adjusting the positions of the first sub-light source unit 211 and the second sub-light source unit 212 in the third direction Z.

Based on the above, in the sixth embodiment, since the second light source module 20 of the illumination system 100C includes a first sub-light source unit 211 and a second sub-light source unit 212 that are offset in orthogonal projection on the plane formed by the second direction Y and the third direction Z to provide the second laser beam L2, the energy of the first laser beam L2 may be more evenly distributed in the illumination beam I, thereby avoiding excessive concentration of energy in the illumination beam I.

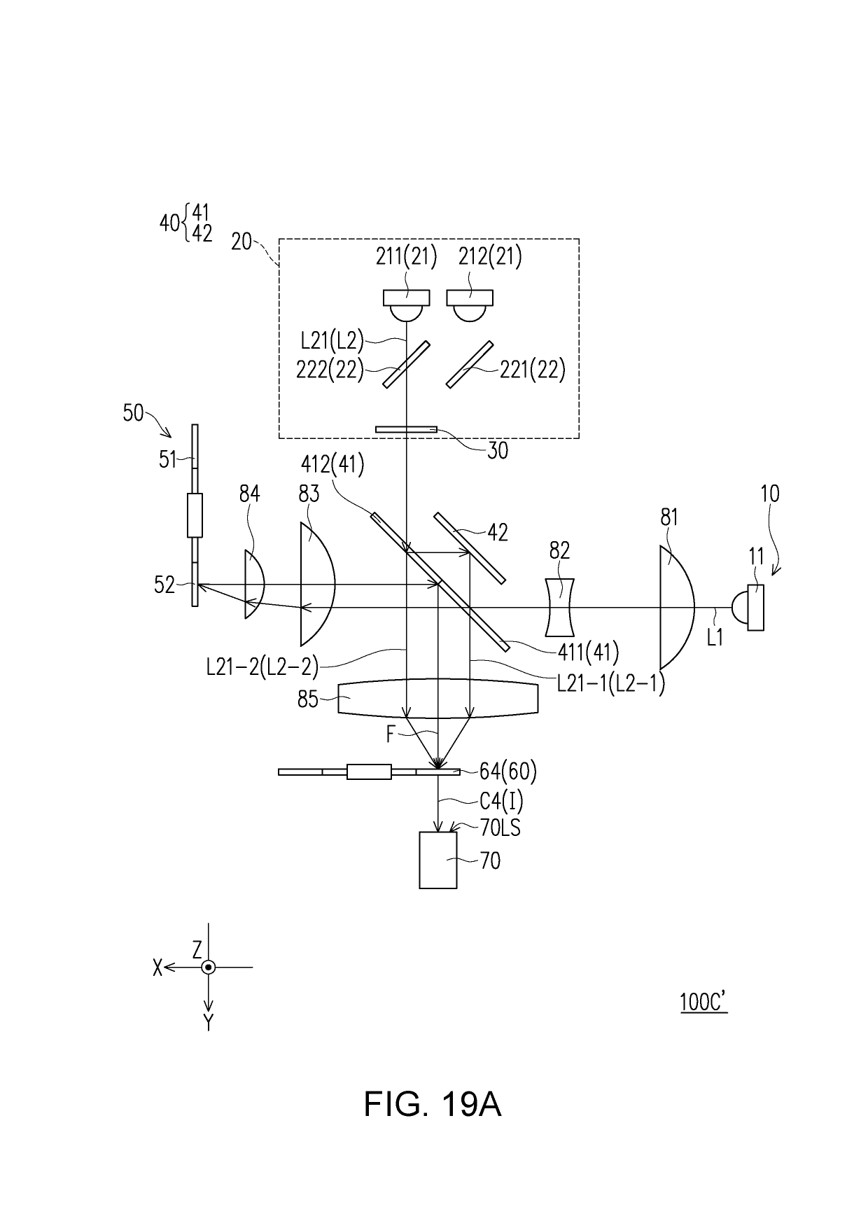

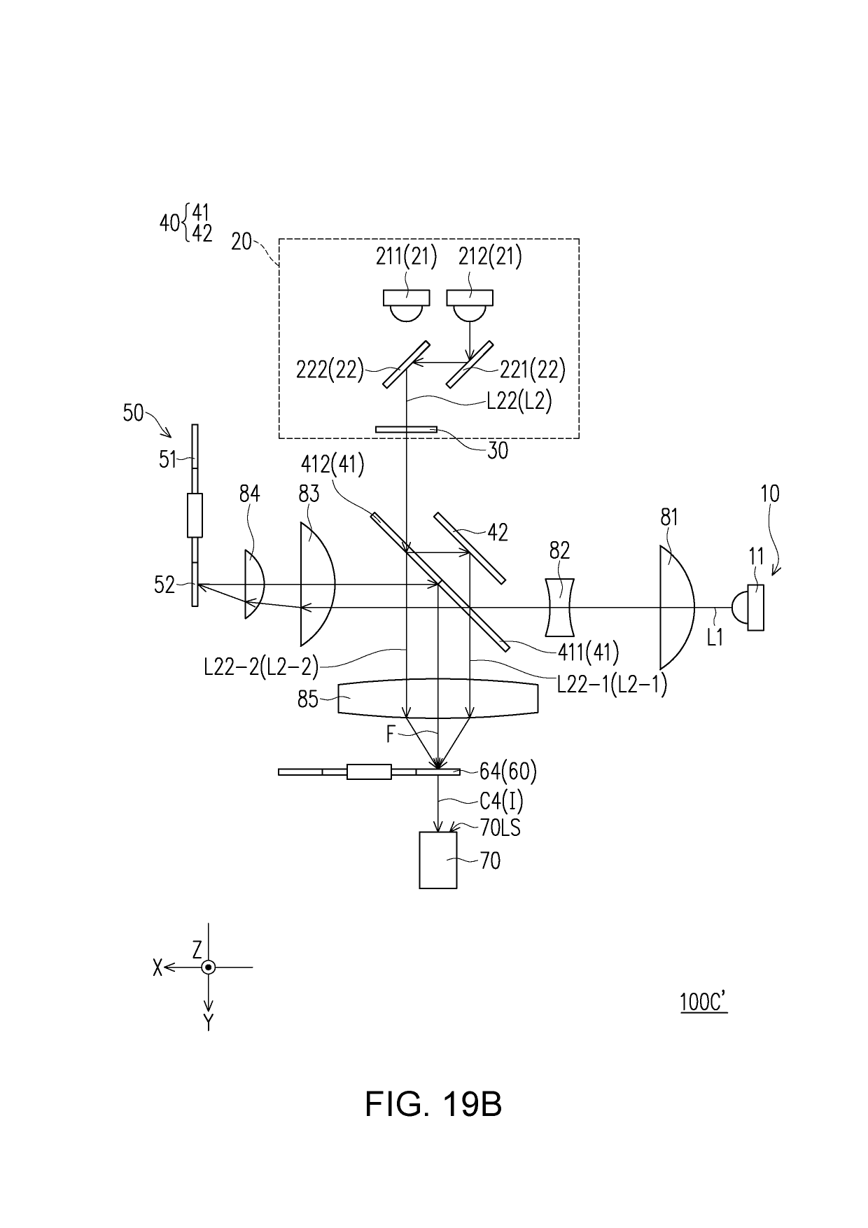

FIG. 19A is a schematic diagram of an optical path corresponding to the first sub-light beam of the illumination system in the fourth time period according to a seventh embodiment of the present invention. FIG. 19B is a schematic diagram of an optical path corresponding to the second sub-light beam of the illumination system in the fourth time period according to a seventh embodiment of the present invention.

Referring to FIG. 19A and FIG. 19B, in the seventh embodiment of the present invention, the system structure of the illumination system 100C' is substantially the same as that of the sixth embodiment, and the working time period of the illumination system 100C' is the same as the working time period of the illumination system 100' of the third embodiment. In other words, the difference between the seventh embodiment and the sixth embodiment is that in the fourth time period, the first light source module 10 is turned on to provide the first laser beam L1, and the first sub-light source unit 211 and the second sub-light source unit 212 of the second light source module 20 are both turned on to simultaneously provide the first sub-light beam L21 and the second sub-light beam L22. In the fourth time period of the present embodiment, the second area 52 of the wavelength conversion device 50 enters the optical path of the first laser beam L1 and is configured to convert the first laser beam L1 into the converted beam F. The light beams L21-1, L21-2, L22-1, and L22-2 formed by the first sub-light beam L21 and the second sub-light beam L22 serve as supplementary light of the fourth time period and enter the condensing lens 85 and the filtering device 60 together with the converted beam F, so that the converted beam F and the light beams L21-1, L21-2, L22-1, and L22-2 passing through the fourth filter area 64 of the filtering device 60 form the fourth color beam C4 serving as the illumination beam I. For reasons similar to those of the third embodiment, the light intensities of the first sub-light beam L21 and the second sub-light beam L22 in the fourth time period are less than the light intensities of the first sub-light beam L21 and the second sub-light beam L22 in the second time period.

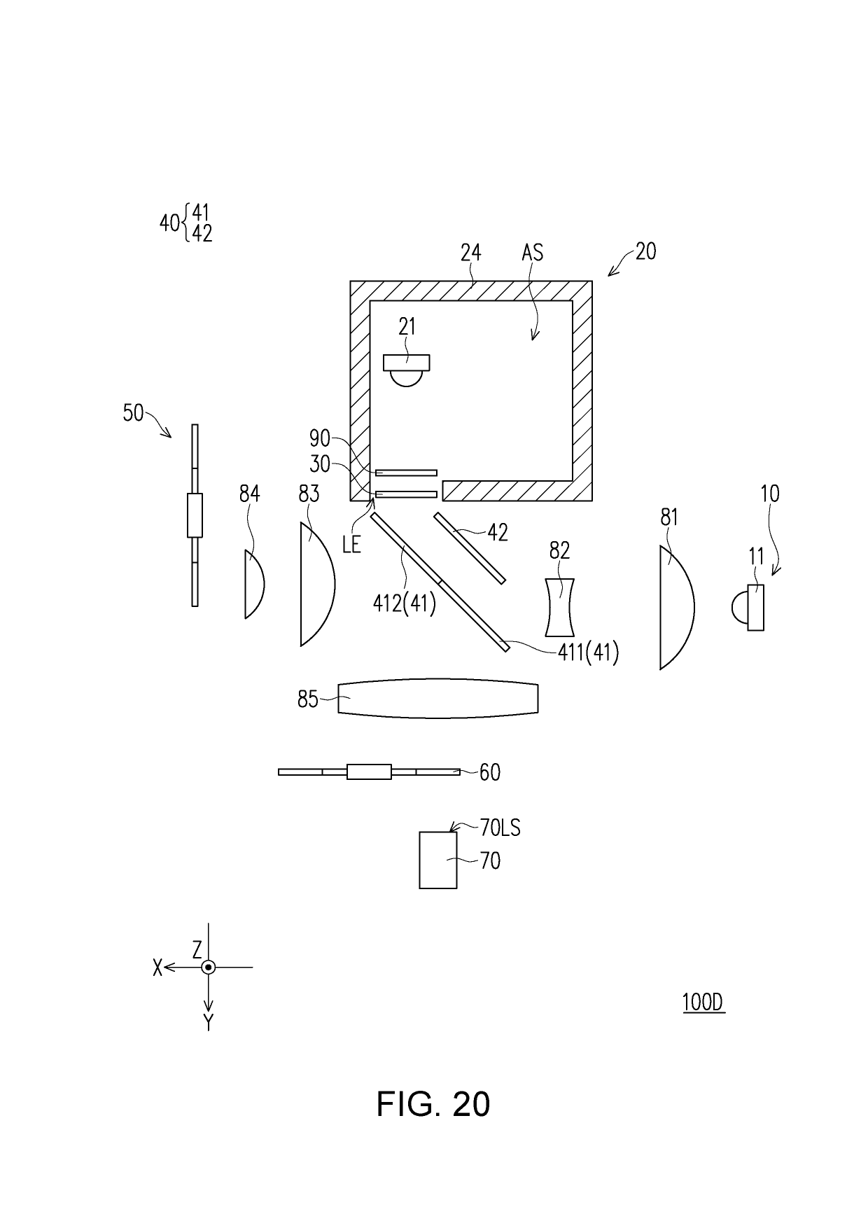

FIG. 20 is a schematic diagram of an illumination system according to an eighth embodiment of the present invention. Referring to FIG. 20, the illumination system 100D of the eighth embodiment is similar to the illumination systems of the first to third embodiments, and the main difference is that the second light source module 20 includes an opaque housing 24. The opaque housing 24 has an accommodating space AS and a light outlet LE, and the light outlet LE communicates the accommodating space AS with the external space. The second light source unit 21 is disposed in the accommodating space AS.

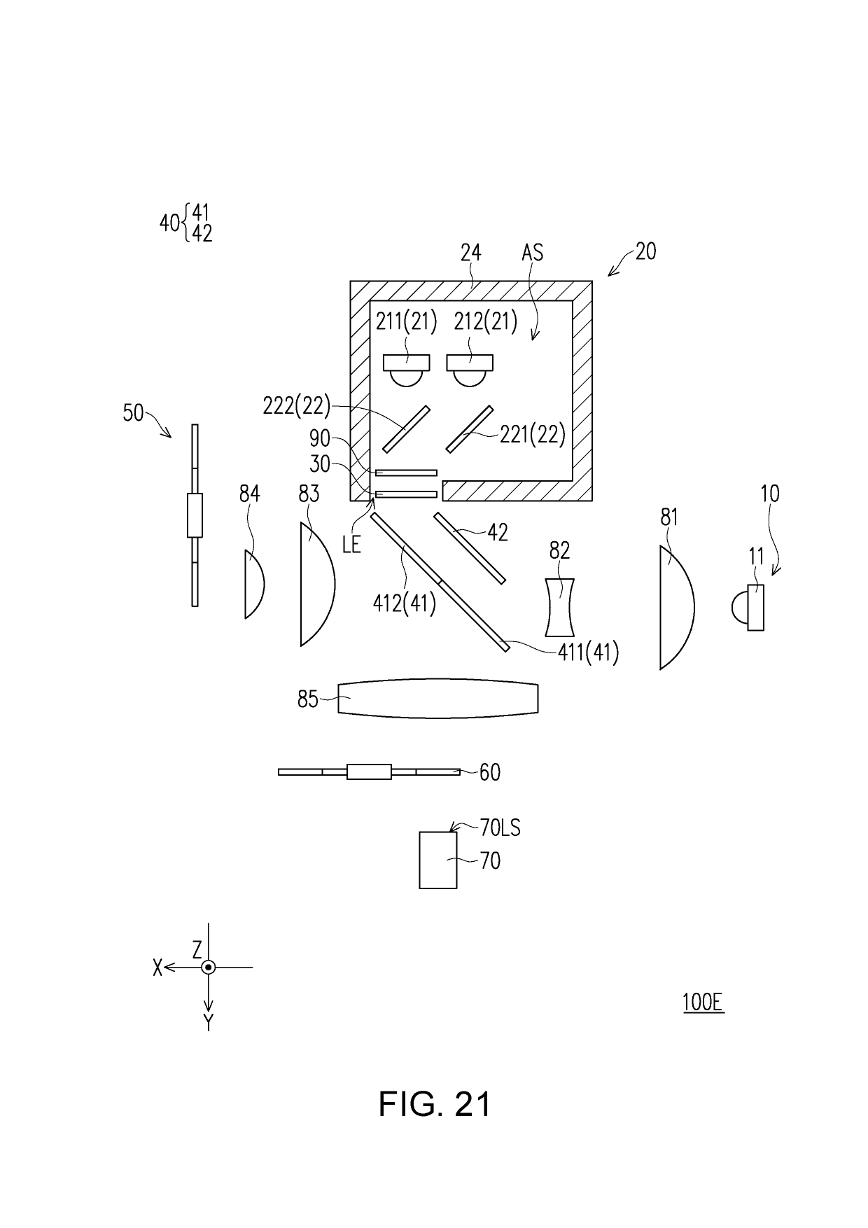

FIG. 21 is a schematic diagram of an illumination system according to a ninth embodiment of the present invention. Referring to FIG. 21, the illumination system 100E of the ninth embodiment is similar to the illumination system 100D of the sixth embodiment, and the main difference is that the second light source module 20 includes an opaque housing 24. The opaque housing 24 has an accommodating space AS and a light outlet LE, and the light outlet LE is communicated with the accommodating space AS. The second light source unit 21 is disposed in the accommodating space AS.

In the eighth and ninth embodiments, since the second light source module 20 further includes an opaque housing encapsulating one second light source unit 21 or having two second light source units 21 (the first sub-light source unit 211 and the second sub-light source unit 212), with only the light outlet LE being retained for the second laser beam L2 to leave, the influence of stray light on the aforementioned light source units may be reduced. Preferably, the filter element 30 is disposed at the light outlet LE, so that the stray light from other parts of the light source system is filtered out by the filter element 30 when entering the second light source module 20 through the light outlet LE, further preventing the light source unit in the second light source module 20 from being affected by the stray light. More specifically, the filter element 30 blocks stray light in the illumination system 100 from entering the second light source module 20, greatly reducing the impact of stray energy on the second light source module 20, allowing the second light source module 30 to maintain appropriate operating temperature, preventing inefficiency of the second light source module 30, and thereby enabling the projection apparatus to render colors more precisely in accordance with expectations. Accordingly, the second light source module 20 achieves higher luminous efficiency, thereby enhancing the color rendition of the illumination beam I or the image beam IB.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, configured to provide an illumination beam, the illumination system comprising a first light source module, a second light source module, a light splitting and combining module, a condensing lens, a wavelength conversion device, and a filtering device, wherein:
the first light source module is configured to provide a first laser beam, the second light source module is configured to provide a second laser beam, and a wavelength range of the first laser beam does not overlap with a wavelength range of the second laser beam;
the second light source module has a light outlet for the second laser beam to leave;
the wavelength conversion device is disposed on an optical path of the first laser beam and has a first area and a second area, the first area and the second area enter the optical path of the first laser beam at different time periods, wherein the first area reflects the first laser beam, and the second area receives the first laser beam and generates a converted beam; a wavelength range of the converted beam at least partially overlaps with the wavelength range of the second laser beam;
the light splitting and combining module is disposed on optical paths of the first laser beam, the second laser beam and the converted beam, the first laser beam from the first light source module is transmitted to the light splitting and combining module along a first direction, the second laser beam from the second light source module is transmitted to the light splitting and combining module along a second direction, wherein the first direction is not parallel to the second direction; the light splitting and combining module is configured to allow the first laser beam from the first light source module to pass through, and the light splitting and combining module splits the first laser beam from the first area of the wavelength conversion device into a first split beam and a second split beam in a time period, and transmits the first split beam and the second split beam to the condensing lens along the second direction, the first split beam and the second split beam enter the condensing lens symmetrically with respect to a central axis of the condensing lens;
the light splitting and combining module is further configured to split the second laser beam from the second light source module into a third split beam and a fourth split beam in another time period, and then to transmit the third split beam and the fourth split beam to the condensing lens along the second direction, the third split beam and the fourth split beam enter the condensing lens symmetrically with respect to the central axis;
the light splitting and combining module is further configured to change a transmission direction of the converted beam so that the converted beam enters the condensing lens along the second direction;
the condensing lens is disposed between the light splitting and combining module and the filtering device, and is configured to converge the first split beam, the second split beam, the third split beam, the fourth split beam and the converted beam, which are transmitted to the filtering device; and
the illumination beam comprises at least one of the following beams passing through the filtering device: the first split beam and the second split beam, the third split beam and the fourth split beam, and at least a portion of the converted beam.

2. The illumination system according to claim 1, wherein the second light source module comprises a filter element disposed in the light outlet, and the filter element is configured to allow the second laser beam to pass through and to filter out light beam of other wavelength.

3. The illumination system according to claim 1, wherein the light splitting and combining module comprises a light splitting element and a first reflective element, the light splitting element comprises a first light splitting area and a second light splitting area disposed adjacent to each other;
the first light splitting area is configured to allow the first laser beam and the second laser beam to pass through and to reflect the converted beam, the second light splitting area is configured to partially transmit and partially reflect the first laser beam from the first area of the wavelength conversion device and the second laser beam from the second light source module, and to reflect the converted beam;
a portion of the first laser beam that passes through the second light splitting area forms the first split beam, while another portion of the first laser beam that is reflected by the second light splitting area forms the second split beam; a portion of the second laser beam that is reflected by the second light splitting area forms the third split beam, while another portion of the second laser beam that passes through the second light splitting area forms the fourth split beam;
the first reflective element is disposed on optical paths of the first split beam and the third split beam, and configured to reflect the first split beam and the third split beam, so that the first split beam and the third split beam enter and pass through the first light splitting area of the light splitting element;
the second split beam formed by reflection from the second light splitting area and the first split beam passing through the first light splitting area enter the condensing lens in parallel with each other; the fourth split beam formed by passing through the second light splitting area and the third split beam formed by passing through the first light splitting area enter the condensing lens in parallel with each other; and
the converted beam reflected by the first light splitting area and the second light splitting area of the light splitting element enters the condensing lens.

4. The illumination system according to claim 3, wherein,
the first direction is perpendicular to the second direction;
the light splitting element and the first reflective element are parallel to each other and are not parallel to and not perpendicular to the first direction and the second direction respectively; and
the central axis is parallel to the second direction.

5. The illumination system according to claim 1, wherein the filtering device comprises a first filter area, a second filter area, and a third filter area; a first filtering wavelength range of the first filter area at least partially overlaps with the wavelength range of the first laser beam, a second filtering wavelength range of the second filter area at least partially overlaps with the wavelength range of the second laser beam, and a third filtering wavelength range of the third filter area at least partially overlaps with the wavelength range of the converted beam; wherein
in a first time period, the first light source module provides the first laser beam, the second light source module does not provide the second laser beam, the first area of the wavelength conversion device enters the optical path of the first laser beam, and the first filter area of the filtering device enters optical paths of the first split beam and the second split beam; the first split beam and the second split beam pass through the first filter area and generate a first color beam, and the first color beam is output as the illumination beam from the illumination system;
in a second time period, the first light source module provides the first laser beam and the second light source module provides the second laser beam, the second area of the wavelength conversion device enters the optical path of the first laser beam and is configured to convert the first laser beam into the converted beam, the second filter area of the filtering device enters optical paths of the converted beam, the third split beam and the fourth split beam; the converted light beam, the third split beam and the fourth split beam pass through the second filter area and generate a second color beam, and the second color beam is output as the illumination beam from the illumination system; and
in a third time period, the first light source module provides the first laser beam, the second area of the wavelength conversion device enters the optical path of the first laser beam and is configured to convert the first laser beam into the converted beam, the third filter area of the filtering device enters the optical path of the converted beam, the converted beam passes through the third filter area and generates a third color beam, the third color beam is output as the illumination beam from the illumination system.

6. The illumination system according to claim 5, wherein the filtering device further comprises a fourth filter area, a fourth filtering wavelength range of the fourth filter area includes the wavelength range of the second laser beam, and at least partially overlaps with the wavelength range of the converted beam;
in a fourth time period, the first light source module generates the first laser beam and the second light source module does not provide the second laser beam, the second area of the wavelength conversion device enters the optical path of the first laser beam and is configured to convert the first laser beam into the converted beam, the fourth filter area of the filtering device enters the optical path of the converted beam; the converted beam passes through the fourth filter area and generates a fourth color beam, and the fourth color beam is output as the illumination beam from the illumination system.

7. The illumination system according to claim 5, wherein the filtering device further comprises a fourth filter area, a fourth filtering wavelength range of the fourth filter area comprises the wavelength range of the second laser beam, and at least partially overlaps with the wavelength range of the converted beam;
in a fourth time period, the first light source module provides the first laser beam and the second light source module provides the second laser beam, the second area of the wavelength conversion device enters the optical path of the first laser beam and is configured to convert the first laser beam into the converted beam, the fourth filter area of the filtering device enters optical paths of the converted beam, the third split beam and the fourth split beam;
a light intensity of the second laser beam in the fourth time period is less than a light intensity of the second laser beam in the second time period.

8. The illumination system according to claim 1, wherein the illumination system further comprises a light diffusion element, the light diffusion element is disposed in the light outlet of the second light source module; the second laser beam provided by the second light source module passes through the light diffusion element and enters the light splitting and combining module.

9. The illumination system according to claim 8, wherein the second light source module comprises a filter element disposed in the light outlet, and the filter element is configured to allow the second laser beam to pass through and to filter out light beam of other wavelength, and the filter element is a filter film disposed on the light diffusion element.

10. The illumination system according to claim 3, wherein
the condensing lens is disposed along a reference plane, the reference plane is perpendicular to the central axis of the condensing lens, the central axis has a center point on the reference plane;
the first split beam forms a first light spot on the reference plane, and the first light spot has a first light spot center; the second split beam forms a second light spot on the reference plane, and the second light spot has a second light spot center, the third split beam forms a third light spot on the reference plane, and the third light spot has a third light spot center, the fourth split beam forms a fourth light spot on the reference plane, and the fourth light spot has a fourth light spot center;
the first light spot center and the second light spot center are arranged symmetrically with respect to the center point as a center, the third light spot center and the fourth light spot center are arranged symmetrically with the center point as a center.

11. The illumination system according to claim 10, wherein the first light spot center overlaps with the third light spot center, and the second light spot center overlaps with the fourth light spot center.

12. The illumination system according to claim 3, wherein the second light source module comprises a second light source unit, the second light source unit is configured to provide the second laser beam.

13. The illumination system according to claim 12, wherein the second light source module further comprises an opaque housing, the opaque housing has an accommodating space and the light outlet, the light outlet is in communication with the accommodating space, the second light source unit is disposed in the accommodating space.

14. The illumination system according to claim 3, wherein the second light source module comprises a first sub-light source unit, a second sub-light source unit and a light guide assembly, the first sub-light source unit is configured to provide a first sub-light beam along the second direction, the second sub-light source unit is configured to provide a second sub-light beam;
the light guide assembly is disposed on a transmission path of the second sub-light beam and is configured to direct the second sub-light beam so that the second sub-light beam is transmitted along the second direction, and the second sub-light beam and the first sub-light beam coincide in the first direction and are offset in a third direction; the first direction, the second direction, and the third direction are perpendicular to each other;
the second laser beam comprises the first sub-light beam provided by the first sub-light source unit and the second sub-light beam leaving from the light guide assembly.

15. The illumination system according to claim 14, wherein the light guide assembly comprises a second reflective element and a third reflective element; setting positions of the first sub-light source unit and the second sub-light source unit coincide in the second direction, and do not coincide in the first direction and the third direction;
the second reflective element is disposed corresponding to the second sub-light source unit in the third direction and the first direction, the third reflective element is disposed corresponding to the second sub-light source unit in the third direction, corresponding to the first reflective element in the second direction, and corresponding to the first sub-light source unit in the first direction;
the second sub-light beam provided by the second sub-light source unit is first reflected by the second reflective element and then transmitted to the third reflective element along the first direction, then, the second sub-light beam is reflected by the third reflective element and then leaves the light guide assembly along the second direction.

16. The illumination system according to claim 14, wherein the third split beam comprises a portion of the first sub-light beam and a portion of the second sub-light beam, the fourth split beam comprises another portion of the first sub-light beam and another portion of the second sub-light beam;
the condensing lens is disposed along a reference plane, the reference plane is perpendicular to the central axis of the condensing lens, the central axis has a center point on the reference plane;
the first split beam forms a first light spot on the reference plane, and the first light spot has a first light spot center; the second split beam forms a second light spot on the reference plane, and the second light spot has a second light spot center;
the portion of the first sub-light beam in the third split beam forms a first sub-light spot on the reference plane, the first sub-light spot has a first sub-light spot center; the portion of the second sub-light beam in the third split beam forms a second sub-light spot on the reference plane, the second sub-light spot has a second sub-light spot center;
the another portion of the first sub-light beam in the fourth split beam forms a third sub-light spot on the reference plane, the third sub-light spot has a third sub-light spot center; the another portion of the second sub-light beam in the fourth split beam forms a fourth sub-light spot on the reference plane, the fourth sub-light spot has a fourth sub-light spot center;
a distance between the first light spot center and the center point is equal to a distance between the second light spot center and the center point;
the distance between the first sub-light spot center and the center point, the distance between the second sub-light spot center and the center point, a distance between the third sub-light spot center and the center point, and a distance between the fourth sub-light spot center and the center point are equal to each other.

17. The illumination system according to claim 14, wherein the second light source module comprises an opaque housing, the opaque housing has an accommodating space and the light outlet, the light outlet is in communication with the accommodating space, the first sub-light source unit and the second sub-light source unit are disposed in the accommodating space.

18. The illumination system according to claim 1, wherein the illumination system further comprises a light homogenizing element, the light homogenizing element is disposed on a transmission path of the illumination beam, and has a light incident surface and a central axis;
a focal point of the condensing lens is located on the light incident surface or inside the light homogenizing element, the central axis of the light homogenizing element is parallel to an optical axis of the condensing lens.

19. A projection apparatus, comprising the illumination system according to claim 1, a light modulation device and a projection lens, wherein:
the illumination system is configured to provide the illumination beam, the light modulation device is disposed on a transmission path of the illumination beam to convert the illumination beam into an image beam, and the projection lens is disposed on a transmission path of the image beam to project the image beam out of the projection apparatus.

20. The projection apparatus according to claim 19, wherein the illumination system further comprises a light homogenizing element, the light homogenizing element is disposed between the filtering device and the light modulation device, and is located on the transmission path of the illumination beam, and has a light incident surface and a central axis;
a focal point of the condensing lens is located on the light incident surface or inside the light homogenizing element, the central axis of the light homogenizing element is parallel to an optical axis of the condensing lens.
